(19) United States
(12) Patent Application Publication
(10) Pub. No.: US 2026/0253409 A1
(43) Pub. Date: Aug. 27, 2026

(54) SAMPLE PURIFICATION METHOD AND APPARATUS, DEVICE, AND MEDIUM

(71) Applicant: Tencent Technology (Shenzhen) Company Limited, Shenzhen (CN)

(72) Inventors: Yudong ZHANG, Shenzhen (CN); Ruobing XIE, Shenzhen (CN); Xingwu SUN, Shenzhen (CN); Zhanhui KANG, Shenzhen (CN)

(73) Assignee: Tencent Technology (Shenzhen) Company Limited, Shenzhen, GD (CN)

(21) Appl. No.: 19/642,044

(22) Filed: Apr. 8, 2026

Related U.S. Application Data
(63) Continuation of application No. PCT/CN2025/096787, filed on May 23, 2025.

(30) Foreign Application Priority Data
Jul. 23, 2024 (CN) 202410994732.0

(51) Int. Cl. G06V 10/98; G06V 10/80; G06V 10/82

(52) U.S. Cl. CPC G06V 10/98; G06V 10/80; G06V 10/82

(57) ABSTRACT

This application discloses a sample purification method and apparatus, a device, and a medium, and belongs to the technical field of artificial intelligence. The method includes: acquiring an adversarial sample, the adversarial sample including an adversarial image and text; acquiring a noisy image obtained by adding first noise to the adversarial image; determining a first correlation and a second correlation; and adding second noise to the adversarial image based on the first correlation and the second correlation to purify the adversarial image to obtain a purified image.

### RELATED APPLICATION

This application is a continuation of International Patent Application No. PCT/CN2025/096787, filed May 23, 2025, which claims priority to Chinese Patent Application No. 202410994732.0, entitled “SAMPLE PURIFICATION METHOD AND APPARATUS, DEVICE, AND MEDIUM” filed with the China National Intellectual Property Administration on Jul. 23, 2024. The contents of International Patent Application No. PCT/CN2025/096787 and Chinese Patent Application No. 202410994732.0 are herein incorporated by reference in their entirety.

### FIELD OF THE TECHNOLOGY

Embodiments of this application relate to the technical field of artificial intelligence, and in particular, to a sample purification method and apparatus, a device, and a medium.

### BACKGROUND OF THE DISCLOSURE

Large vision-language models (LVLMs) are widely defined as multimodal models that can learn from images and text. The LVLM (vision-language model for short) is vulnerable to adversarial samples during task execution. The adversarial sample is a sample that makes the LVLM generate incorrect predictions by slightly modifying or perturbing a clean sample.

In the related art, the adversarial samples are purified by performing some preprocessing operations on images inputted to the LVLM. For example, a smoothing operation is performed on the image, that is, a smoothing filter is adopted to reduce image noise, thereby reducing the impact of adversarial attacks. For another example, a scale change operation is performed on the image, that is, image features are changed by changing the scale (for example, scaling) of the image, thereby reducing the effectiveness of adversarial attacks.

However, in the related art, purification of the adversarial samples primarily relies on conventional image processing technologies, resulting in suboptimal purification effects of the adversarial samples. In actual application, the adversarial samples still adversely affect the task outputs (prediction results) of the LVLM.

### SUMMARY

This application provides a sample purification method and apparatus, a device, and a medium. Technical solutions are as follows.

According to an aspect of this application, a sample purification method is provided, including:
acquiring an adversarial sample, the adversarial sample being generated by performing an adversarial attack on a clean sample, and the adversarial sample including an adversarial image and text;
acquiring a noisy image obtained by adding first noise to the adversarial image;
determining a first correlation between at least one noisy image feature of the noisy image and at least one text feature of the text;
determining a second correlation between at least one adversarial image feature of the adversarial image and the at least one text feature of the text; and
adding second noise to the adversarial image based on the first correlation and the second correlation to purify the adversarial image to obtain a purified image.

According to an aspect of this application, a sample purification apparatus is provided, including an acquisition module, a determining module, and an addition module,
the acquisition module being configured to:
acquire an adversarial sample, the adversarial sample being generated by performing an adversarial attack on a clean sample, and the adversarial sample including an adversarial image and text; and
acquire a noisy image obtained by adding first noise to the adversarial image;
the determining module being configured to:
determine a first correlation between at least one noisy image feature of the noisy image and at least one text feature of the text; and
determine a second correlation between at least one adversarial image feature of the adversarial image and the at least one text feature of the text; and
the addition module being configured to add second noise to the adversarial image based on the first correlation and the second correlation to purify the adversarial image to obtain a purified image.

According to another aspect of this application, a computer device is provided, including a processor and a memory, the memory having at least one computer program stored therein, and the at least one computer program being loaded and executed by the processor to implement the sample purification method according to the foregoing aspect.

According to another aspect of this application, a computer-readable storage medium is provided, having at least one computer program stored therein, and the at least one computer program being loaded and executed by a processor to implement the sample purification method according to the foregoing aspect.

According to another aspect of this application, a computer program product is provided, including a computer program, the computer program being stored in a computer-readable storage medium; and the computer program being read from the computer-readable storage medium and executed by a processor of a computer device to cause the computer device to perform the sample purification method according to the foregoing aspect.

The technical solutions provided in this application have at least the following beneficial effects.

The LVLM may generate incorrect predictions based on the adversarial sample. A purification operation is performed on the adversarial image in the adversarial sample to obtain the purified image, so as to obtain the purified sample. Specifically, the noisy image is obtained by performing random noise addition on the adversarial image. Since a noisy cross-modal attention distribution (i.e., the first correlation between the at least one noisy image feature of the noisy image and the at least one text feature of the text) of the noisy image is very close to a cross-modal attention distribution (i.e., a correlation between at least one clean image feature of the clean image and at least one text feature of text) corresponding to a clean image, the noisy cross-modal attention distribution of the noisy image may be used as an optimization target, and random noise is added to the adversarial image, so that an adversarial cross-modal attention distribution (i.e., the second correlation between the at least one adversarial image feature of the adversarial image and the at least one text feature of the text) of the adversarial image is close to the noisy cross-modal attention distribution of the noisy image, to complete purification of the adversarial image and obtain the purified image. In this application, with guidance of the noisy cross-modal attention distribution, the adversarial image is purified by adding noise to the adversarial image. The LVLM may obtain a correct prediction result based on the purified image, and this purification manner enhances the robustness of the LVLM.

Further, the manner of guiding the addition of random noise to the adversarial image by taking the noisy cross-modal attention distribution as an estimation direction not only optimizes the adversarial image, but also optimizes the cross-modal attention distribution itself. Such optimization enables an attention mechanism to more accurately focus on key information in an image, thereby improving the accuracy of prediction results outputted by the LVLM.

### BRIEF DESCRIPTION OF THE DRAWINGS

To more clearly illustrate the technical solutions in embodiments of this application, the drawings required in the descriptions of the embodiments will be briefly introduced below. It is clear that the drawings described below are only some embodiments of this application, and a person skilled in the art may obtain other drawings according to these drawings without involving any inventive efforts.

FIG. 1 is a schematic architectural diagram of a computer system according to an exemplary embodiment of this application.

FIG. 2 is a schematic diagram of a sample purification method according to an exemplary embodiment of this application.

FIG. 3 is a flowchart of a sample purification method according to an exemplary embodiment of this application.

FIG. 4A is a flowchart of a sample purification method according to an exemplary embodiment of this application.

FIG. 4B is a flowchart of a sample purification method according to an exemplary embodiment of this application.

FIG. 5 is a flowchart of a sample purification method according to an exemplary embodiment of this application.

FIG. 6 is a flowchart of a sample purification method according to an exemplary embodiment of this application.

FIG. 7 is a structural block diagram of a sample purification apparatus according to an exemplary embodiment of this application.

FIG. 8 is a schematic structural diagram of a computer device according to an exemplary embodiment of this application.

### DESCRIPTION OF EMBODIMENTS

To make the objectives, technical solutions, and advantages of this application clearer, implementations of this application will be described in further detail below with reference to the accompanying drawings.

Exemplary embodiments are described in detail here, and examples are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of an apparatus and a method that are consistent with some aspects of this application described in detail in claims.

The terms used in this application are merely intended to describe specific embodiments, but are not intended to limit this application. As used in this application and the appended claims, the singular forms “a”, “the”, and “this” are intended to include the plural forms as well, unless the context clearly indicates otherwise. The term “and/or” as used herein refers to and encompasses any or all possible combinations of one or more of the associated listed items.

Although the terms such as “first” and “second” may be used in the present disclosure to describe various information, the information is not to be limited to these terms. These terms are merely intended to distinguish information of the same type. For example, without departing from the scope of the present disclosure, a first parameter may alternatively be referred to as a second parameter. Similarly, a second parameter may alternatively be referred to as a first parameter. Depending on the context, for example, the word “if” used herein may be interpreted as “while”, “when”, or “in response to determining”.

Data (including, but not limited to, data for analysis, data for training, data for recommending, and the like) involved in this application are all information and data authorized by a user or fully authorized by all parties. Collection, use, and processing of relevant data need to comply with relevant laws, regulations, and standards of relevant countries and regions. For example, information such as a setting operation involved in this application is acquired under full authorization.

Before the technical solutions of this application are described, some terms involved in this application are explained first. The following related explanations may be randomly combined with the technical solutions in the embodiments of this application as exemplary solutions, and shall fall within the protection scope of the embodiments of this application. The embodiments of this application include at least some of the following content.

An LVLM is a multimodal model combining vision (image) and language (text) that may receive image and text inputs and generate task outputs. The LVLM can understand and process an association between an image and text, and is configured for processing various tasks, such as image captioning, visual question answering (VQA), and image-text matching.

A clean sample refers to an original sample that has not been modified or perturbed. The clean sample is a standard sample in an ideal state, and plays a benchmark role in evaluation of the LVLM. The clean sample includes a clean image and text.

An adversarial sample is a sample that makes the LVLM generate incorrect predictions by slightly modifying or perturbing the clean sample. Perturbations in the adversarial sample are imperceptible, but they may cause the LVLM to make incorrect predictions or outputs. The adversarial sample includes an adversarial image and text. In the embodiments of this application, a purification operation on the adversarial sample may be regarded as a purification operation on the adversarial image.

A noisy sample is an adversarial sample generated by adding random noise to an original adversarial sample. A range of random noise addition is limited or constrained by an infinite norm. An objective of randomly adding noise to the adversarial sample is to maintain the adversarial property while making the cross-modal attention distribution of the noisy sample close to the cross-modal attention distribution of the clean sample. The noisy sample includes a noisy image and text.

A purified sample refers to a sample obtained after purifying a slight modification or perturbation in the adversarial sample. The purified sample may improve a probability that the LVLM generates correct predictions. An objective of the purified sample is to reduce adversarial perturbations causing incorrect predictions of the LVLM and improve the probability that the LVLM generates correct predictions. The purified sample includes a purified image and text. In the embodiments of this application, obtaining the purified sample through the purification operation on the adversarial sample may be understood as obtaining the purified image through the purification operation on the adversarial image.

A visual token is a feature representation extracted from the image, and is obtained after encoding through a visual encoder in the LVLM. The visual encoder divides an input image into several regions. Each region may be encoded into an image feature (or referred to as a visual feature or a regional image feature). The several regions may be encoded into several image features, and the several image features are aligned through a language alignment module in the LVLM to obtain a plurality of visual tokens. Each visual token may be a fused representation of the several image features. For example, one region of the image corresponds to one image feature, and one visual token may be a feature representation obtained after fusing several image features. Exemplarily, the visual encoder in the LVLM divides an image into 16×16=256 regions and extracts 256 image features. The language alignment module processes the image into 32 visual tokens, and each visual token may be a fused representation of 256 image features. In some embodiments, different visual tokens emphasize different aspects when fusing image features. For example, a first visual token focuses primarily on a background region in the image, that is, the first visual token primarily represents the image feature of the background region. A second visual token focuses primarily on an object region in the image, that is, the second visual token primarily represents the image feature of the object region.

A language token is a feature representation extracted from text, and is obtained after encoding through a language model tokenizer in the LVLM. In some embodiments, the language model tokenizer divides input text into several words (or subwords), and then converts each word into a corresponding feature vector. The text may usually be divided into several subwords, a feature vector of each subword may be represented as one language token, and one language token usually corresponds to one subword in the text. Alternatively, feature vectors of a plurality of subwords may be represented as one language token. One language token usually corresponds to a plurality of subwords in the text. For example, one language token is the text features of all subwords in the text.

A cross-modal attention distribution refers to an attention mechanism of the LVLM when processing multimodal data. The cross-modal attention distribution refers to how one modality (for example, text) allocates attention or focus according to the content of another modality (for example, image) in multimodal data processing. In the examples of this application, the cross-modal attention distribution refers to how the LVLM focuses on a related part of an image in a sample when generating a prediction result.

Exemplarily, in an application scene of VQA, when processing an image, the LVLM can focus on image regions related to descriptive text or questions based on the cross-modal attention distribution. For example, a task of the LVLM is to answer a question in an image. An image input of the LVLM is a red car driving on a highway, and a text input of the LVLM is a question “What is the color of the car?”. When generating a first word “red” of the answer, the LVLM calculates attention weights of all visual tokens (preset image features) in the image. The attention weight represents the importance of each visual token to the currently generated word. That is, the LVLM evaluates the extent to which each visual token affects the generation of the first word “red”. In some embodiments, the LVLM may focus primarily on a visual token representing a car part in the image.

In the embodiments of this application, a purification operation is primarily performed on the adversarial image in the adversarial sample to obtain the purified sample having the purified image. Unless otherwise specified, the cross-modal attention distribution corresponding to the clean sample may be equivalently understood as the cross-modal attention distribution corresponding to the clean image. The cross-modal attention distribution corresponding to the adversarial sample may be equivalently understood as the cross-modal attention distribution corresponding to the adversarial image. The cross-modal attention distribution corresponding to the noisy sample may be equivalently understood as the cross-modal attention distribution corresponding to the noisy image. The cross-modal attention distribution corresponding to the purified sample may be equivalently understood as the cross-modal attention distribution corresponding to the purified image.

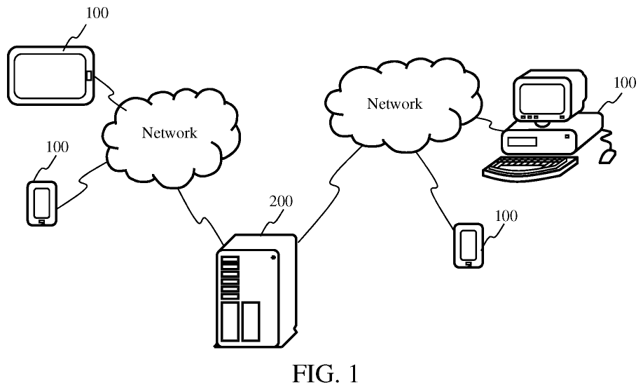

FIG. 1 is a schematic architectural diagram of a computer system according to an embodiment of this application. The computer system may include a terminal 100 and a server 200.

The terminal 100 may be an electronic device such as a mobile phone, a tablet computer, an in-vehicle terminal (in-vehicle infotainment), a wearable device, a personal computer (PC), or an in-vehicle terminal. A client running a target application (App) may be installed in the terminal 100. The target App may be an App supporting sample purification. This is not limited in this application. In addition, the form of the target App is not limited in this application. The target App includes, but is not limited to, an App, a mini program, a client, or the like installed in the terminal 100, or may be in the form of a web page.

The server 200 may be an independent physical server, may be a server cluster or a distributed system including a plurality of physical servers, or may be a cloud server that provides basic cloud computing services such as a cloud server, a cloud database, cloud computing, a cloud function, cloud storage, a network service, cloud communication, a middleware service, a domain name service, a security service, a content delivery network (CDN), and a big data and artificial palm image recognition platform. The server 200 may be a backend server of the target App, and is configured to provide a backend service for a client of the target App.

The cloud technology refers to a hosting technology that unifies a series of resources such as hardware, software, and networks in a wide area network or a local area network to realize data calculation, storage, processing, and sharing. The cloud technology, a general term for network technology, information technology, integration technology, management platform technology, and application technology that are applied based on a commercial mode of cloud computing, may form a resource pool and may be used on demand, which is flexible and convenient. The cloud computing technology will become an important support. The background service of a technical network system requires many computing and storage resources, for example, video websites, picture websites, and more portal websites. With the rapid development and application of the Internet industry, each item may have its own recognition mark in the future, and the recognition marks need to be transmitted to a backend system for logical processing. Data of different levels is processed separately, and all kinds of industry data require a strong system support, which can be realized only through the cloud computing.

In some embodiments, the server may alternatively be implemented as a node in a blockchain system. The blockchain is a new application mode of computer technologies such as distributed data storage, peer-to-peer transmission, a consensus mechanism, and an encryption algorithm. The blockchain is essentially a decentralized database and includes a series of data blocks generated associatively through a cryptographic method. Each data block contains information of a batch of network transactions to verify the effectiveness of the information (anti-counterfeiting) and generate a next block. The blockchain may include a blockchain bottom platform, a platform product service layer, and an application service layer.

The terminal 100 and the server 200 may communicate with each other through a network, for example, a wired or wireless network.

In the sample purification method provided in the embodiments of this application, operations may be performed by a computer device. The computer device refers to an electronic device having data computing, processing, and storage capabilities. Using a computer system shown in FIG. 1 as an example, the sample purification method may be performed by the terminal 100, by the server 200, or jointly by the terminal 100 and the server 200 through interaction. This is not limited in this application.

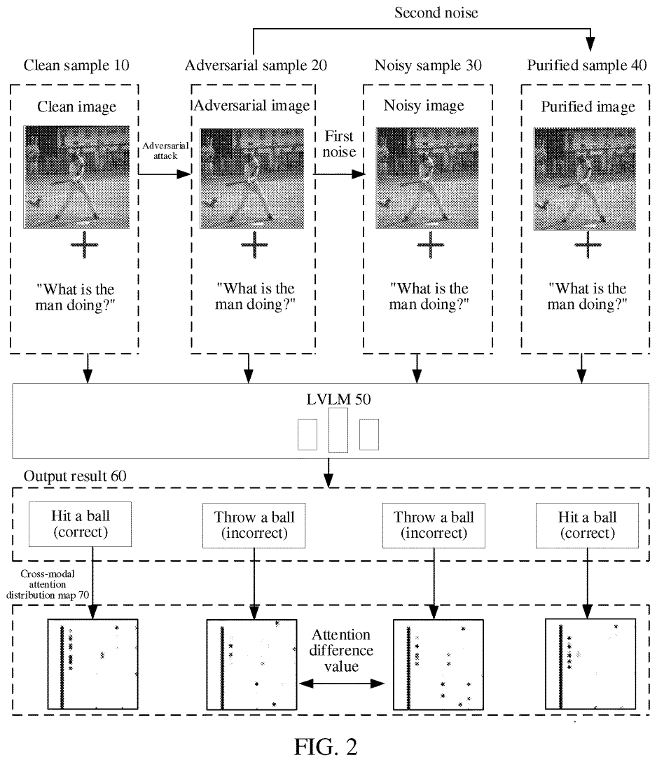

Exemplarily, FIG. 2 is a schematic diagram of a sample purification method according to an exemplary embodiment of this application. This method is performed by a computer device, and the computer device may be the terminal 100 and/or the server 200 in FIG. 1. In this embodiment, an example in which the computer device is the server 200 is used for description. The server 200 performs the sample purification method.

In the related art, the adversarial samples are purified by performing some preprocessing operations on images inputted to the LVLM. For example, a smoothing operation is performed on the image, that is, a smoothing filter is adopted to reduce image noise, thereby reducing the impact of adversarial attacks. For another example, a scale change operation is performed on the image, that is, image features are changed by changing the scale (for example, scaling) of the image, thereby reducing the effectiveness of adversarial attacks. However, in the related art, purification of the adversarial samples primarily relies on conventional image processing technologies, resulting in suboptimal purification effects of the adversarial samples. In actual application, the adversarial samples still adversely affect the task outputs of the LVLM.

To resolve the foregoing problem, this application provides a sample purification method. To reduce the adversarial attack in the adversarial sample and enable the LVLM to generate a correct prediction result, the adversarial sample (primarily the adversarial image in the adversarial sample) inputted to the LVLM may be purified, and a purified sample (purified image) is obtained after a purification process. In this embodiment of this application, a cross-modal attention distribution is used as a target direction of the purification process to guide the adversarial sample to complete a purification operation. In some embodiments, random noise is added to the adversarial sample to guide an adversarial cross-modal attention distribution of the adversarial sample to be close to a clean cross-modal attention distribution of a clean sample, thereby making the LVLM generate a correct prediction result.

In an application scene of VQA, the LVLM may answer a natural language question about an image. Exemplarily, description is provided with reference to FIG. 2. A clean sample 10 includes a clean image and text. An adversarial sample 20 includes an adversarial image and text. A noisy sample 30 includes a noisy image and text. A purified sample 40 includes a purified image and text. The text of the clean sample 10, the adversarial sample 20, the noisy sample 30, and the purified sample 40 is a description “what is the man doing?” of a natural language question.

In some embodiments, the clean sample 10 is inputted to an LVLM 50, and an output result 60 may be obtained, that is, a correct answer “hit a ball” is obtained. When generating the answer “hit a ball”, the LVLM 50 calculates a clean cross-modal attention distribution of the clean image in the clean sample 10. In some embodiments, the LVLM 50 calculates attention weights of all visual tokens in the clean image. The LVLM 50 divides the clean image into several regions. An image feature of each region (or image features corresponding to a plurality of regions) may be represented as one visual token. The attention weight represents the importance of each visual token to an answer “hit a ball”. That is, the LVLM evaluates the extent to which each visual token affects the generation of “hit a ball”. In some embodiments, a cross-modal attention distribution map 70 is a visual representation of the cross-modal attention distribution, and presents attention degrees of the LVLM to different visual tokens in the image when processing a task.

In some embodiments, cross-modal attention distributions of the clean sample 10 and the adversarial sample 20 are significantly different. This may alternatively be understood as that cross-modal attention distributions of the clean image and the adversarial image are significantly different. An adversarial cross-modal attention distribution of the adversarial sample 20 may be guided to be close to the clean cross-modal attention distribution of the clean sample 10, thereby purifying the adversarial sample 20. However, in an adversarial purification scene, the clean sample 10 usually cannot be directly acquired. Thus, the clean cross-modal attention distribution of the clean sample 10 cannot be directly acquired.

In a possible implementation, first noise is added to the adversarial image of the adversarial sample 20 to obtain the noisy sample 30. Compared with the adversarial cross-modal attention distribution of the adversarial sample 20, a noisy cross-modal attention distribution of the noisy sample 30 is closer to the clean cross-modal attention distribution corresponding to the clean sample 10 (manifesting as the attention weight distribution in the cross-modal attention distribution map corresponding to the noisy sample 30 being close to the attention weight distribution in the cross-modal attention distribution map corresponding to the clean sample 10). Therefore, the noisy cross-modal attention distribution of the noisy sample 30 is used as a reference estimation direction to guide the optimization of the adversarial cross-modal attention distribution of the adversarial sample 20. This may be regarded as a purification operation on the adversarial sample 20, making the adversarial sample 20 closer to the clean sample 10. In some embodiments, the adversarial cross-modal attention distribution corresponding to the adversarial sample 20 is guided to be close to the noisy cross-modal attention distribution corresponding to the noisy sample 30, thereby purifying the adversarial sample 20.

In some embodiments, the noisy cross-modal attention distribution corresponding to the noisy sample 30 is used as a target, to guide the adversarial cross-modal attention distribution corresponding to the adversarial sample 20 to be close to the noisy cross-modal attention distribution corresponding to the noisy sample 30. In some embodiments, minimizing an attention difference value is used as an optimization target, and second noise is added to the adversarial image to generate the purified image. That is, a purification operation is performed on the adversarial sample 20, and the purified sample 40 is generated. The attention difference value is a difference between the noisy cross-modal attention distribution corresponding to the noisy sample 30 and the adversarial cross-modal attention distribution corresponding to the adversarial sample 20. The LVLM 50 may generate the correct answer “hit a ball” based on the purified sample 40.

In some embodiments, the purified sample 40 is obtained based on the following operations. A norm of the attention difference value is first calculated. The norm of the attention difference value is configured for measuring a distance between the adversarial cross-modal attention distribution corresponding to the adversarial sample 20 and the noisy cross-modal attention distribution corresponding to the noisy sample 30. Then, a gradient of the attention difference value for a pixel in the adversarial image is calculated. The gradient is configured for indicating how to add the second noise to minimize the attention difference value in the current adversarial sample 20. Then, a gradient direction of the gradient is determined based on a sign function. The gradient direction is configured for indicating a direction of adding the second noise to the adversarial image in the adversarial sample 20. That is, the second noise is added to the pixel in the adversarial image, and the pixel in the adversarial image is adjusted toward the gradient direction to reduce the attention difference value. In some embodiments, the gradient is used as an input of the sign function. When the gradient is a positive value, an output of the sign function is 1, that is, the adversarial sample 20 is controlled to increase a pixel value in the adversarial image according to the gradient direction. When the gradient is a negative value, the output of the sign function is −1, that is, the adversarial sample 20 is controlled to reduce the pixel value in the adversarial image according to the gradient direction. When the gradient is zero, the output of the sign function is 0, that is, the adversarial sample is controlled to keep the pixel value in the adversarial image unchanged according to the gradient direction (basically, all pixel values change, with almost no pixel value remaining unchanged). In some embodiments, the pixel value in the adversarial image is increased or decreased according to the gradient direction to obtain the purified image added with the second noise.

In some embodiments, a magnitude of the second noise added to the adversarial image is controlled. In some embodiments, the gradient not only contains information of the gradient direction, but also includes intensity information. The intensity information of the gradient is positively correlated with the magnitude of the added second noise. In some embodiments, the adversarial image in the adversarial sample 20 is divided at the pixel granularity, and second noise of different perturbation degrees (different magnitudes) is added at different pixel positions of the adversarial image based on the gradient direction. In some embodiments, a pixel having a relatively large gradient in the adversarial image shall be subjected to a large perturbation, that is, added with relatively large noise. A pixel having a relatively small gradient in the adversarial image shall be subjected to a relatively small perturbation, that is, added with relatively small noise. In some embodiments, a maximum gradient value and a minimum gradient value are acquired, and a standard gradient value is obtained based on the maximum gradient value and the minimum gradient value. The standard gradient value is a gradient value obtained after normalizing the gradient. The gradient is normalized to [0, 1]. In some embodiments, since the standard gradient values vary significantly, the standard gradient value may be represented based on an average value of the standard gradient values. A perturbation amplitude of the second noise is determined according to the standard gradient value and the average value of the standard gradient values. The perturbation amplitude includes a perturbation factor configured for determining a magnitude of the second noise. Based on the perturbation factor, the magnitude of the second noise added to each pixel in the adversarial image is determined.

In some embodiments, the purified image is obtained through the purification operation on the adversarial image, that is, the purified sample 40 is obtained through the purification operation on the adversarial sample 20. In some embodiments, the purified sample 40 is inputted to the LVLM 50, and the LVLM 50 may obtain a correct output result “hit a ball” based on the purified sample 40.

In this embodiment of this application, the noisy cross-modal attention distribution is alternatively referred to as a first correlation between at least one noisy image feature of the noisy image and at least one text feature of text. The adversarial cross-modal attention distribution is alternatively referred to as a second correlation between at least one adversarial image feature of the adversarial image and the at least one text feature of the text. The attention difference value is alternatively referred to as a correlation difference value.

FIG. 3 is a flowchart of a sample purification method according to an exemplary embodiment of this application. The method may be performed by a computer device, and the computer device may be the terminal 100 or the server 200 in FIG. 1. The method includes the following operations.

Operation 210: Acquire an adversarial sample.

The adversarial sample is a sample generated by performing an adversarial attack on a clean sample. In some embodiments, the clean sample includes a clean image and text. The adversarial sample includes an adversarial image and text.

In some embodiments, the clean sample refers to an original sample that has not been modified or perturbed. The adversarial sample is a sample generated by performing an adversarial attack on a clean sample. The adversarial attack includes slightly modifying or perturbing the clean sample. Modifications or perturbations in the adversarial sample are imperceptible, but they may cause the LVLM to make an incorrect prediction and generate an incorrect prediction result (output result).

In some embodiments, the adversarial sample may be configured for evaluating the performance of the LVLM under slight perturbations. By introducing the adversarial sample, the robustness of the LVLM in actual application may be tested to determine whether the LVLM is vulnerable to attacks or misleading. The adversarial sample may be used as an attack tool to attempt to acquire competitive advantages or perform malicious activities by interfering with the LVLM. Therefore, the purification operation of the adversarial sample is particularly important.

Exemplarily, a cat is displayed in a clean image. In a VQA scene, the LVLM correctly classifies the image as a “cat”. An adversarial attack is applied to the clean image. For example, an adversarial attack is performed on the clean image based on a fast gradient sign method (FGSM), so that an adversarial image may be generated. The generated adversarial image still looks like a cat, but the LVLM may incorrectly classify the image as a “dog” or another category.

In some embodiments, to reduce the adversarial attack in the adversarial sample and enable the LVLM to generate a correct prediction result, a purification operation is performed on the adversarial image in the adversarial sample to obtain the purified image.

Operation 220: Acquire a noisy image obtained by adding first noise to the adversarial image.

The noisy image is an image obtained after performing a first perturbation on the adversarial image. The first noise refers to random noise added to the adversarial image. The first noise is randomly generated or generated according to a rule, to perturb a pixel value of the adversarial image. In some embodiments, the first noise may be Gaussian noise, uniform noise, or other types of random noise.

In some embodiments, the LVLM is a multimodal model combining vision (image) and language (text) that may receive image and text inputs and generate task outputs. The LVLM can understand and process an association between the image and the text, and is configured for processing multiple tasks. In some embodiments, the LVLM includes at least one of a deep neural network (DNN) model, a convolutional neural network (CNN) model, a transformer model, a contrastive language-image pre-training (CLIP) model, an extreme learning machine (ELM) model, or other neural network models, but is not limited thereto. This is not specifically limited in the embodiments of this application.

In some embodiments, the first noise added to the adversarial image is uniform noise. The noisy image may be represented as:

$${x}_{i}^{R} = R ( {x}_{i}^{′} , {α}_{∞} ) = {x}_{i}^{′} - α , α ∼ U [ - {α}_{∞} , {α}_{∞} ] ,$$

where

$${x}_{i}^{R}$$

represents the noisy image,

$${x}_{i}^{′}$$

represents the adversarial image, and α represents the first noise. That is, the first noise is determined based on a first noise value obtained through pseudo-random sampling within a first distribution interval [−α_{∞}, α_{∞}]. The first distribution interval [−α_{∞}, α_{∞}] is a uniformly distributed interval range.

$$R ( {x}_{i}^{′} , {α}_{∞} )$$

indicates adding random noise with an infinite norm limited by α_{∞} to the adversarial image

$${x}_{i}^{′} .$$

In a possible implementation, the first noise is added through a computer program. In some embodiments, a program for adding noise is installed in the computer device. Uniformly distributed first noise may be generated using a programming language (for example, NumPy in Python or an OpenCV library), and the first noise is added to the adversarial image. In some embodiments, the program for adding noise installed in the computer device uses the OpenCV library to read the adversarial image to which the first noise is to be added, and uses a random number generator to generate uniformly distributed random numbers. These random numbers are used as noise values of the first noise. In some embodiments, a value of the generated random noise (first noise) is adjusted according to required noise intensity. The noise intensity may be controlled by adjusting a range of the random number generator. Then, a noise value of the first noise generated by the random number generator is added to a pixel of the adversarial image.

In a possible implementation, the first noise is added through a noise model. For example, the first noise is generated using generative adversarial networks (GANs), variational autoencoders (VAEs), or other deep learning models, and then added to the adversarial image. Exemplarily, an example in which the GAN adds the first noise to the adversarial image to generate the noisy image is used for description. The GAN receives random noise (first noise) as an input. The random noise may be obtained by sampling from the uniform distribution. The GAN outputs a uniformly distributed noise image according to the random noise, then performs noise addition, and adds the generated noise image to the adversarial image. That is, a pixel value of the noise image is superimposed onto the adversarial image to obtain the noisy image. The foregoing is merely exemplary description, and this application does not limit a manner of adding noise.

Operation 230: Determine a first correlation between at least one noisy image feature of the noisy image and at least one text feature of the text.

In other words, the noisy cross-modal attention distribution may be calculated. The noisy cross-modal attention distribution is configured for describing attention distributions of the noisy image and the text.

In some embodiments, cross-modal attention distributions of the clean sample and the adversarial sample are significantly different. This may alternatively be understood as that a clean cross-modal attention distribution of the clean image and an adversarial cross-modal attention distribution of the adversarial image are significantly different. The adversarial cross-modal attention distribution of the adversarial image may be guided to be close to the clean cross-modal attention distribution of the clean image, thereby purifying the adversarial image. However, in an adversarial purification scene, the clean image usually cannot be directly acquired. Thus, the clean cross-modal attention distribution of the clean image cannot be directly acquired.

In a possible implementation, the first noise is added to the adversarial image to obtain the noisy image. Compared with the adversarial cross-modal attention distribution of the adversarial image, the noisy cross-modal attention distribution of the noisy image is closer to the clean cross-modal attention distribution of the clean image. Therefore, the noisy cross-modal attention distribution of the noisy image is used as a reference estimation direction to guide the optimization of the adversarial cross-modal attention distribution of the adversarial image. This may be regarded as a purification operation on the adversarial image, making the adversarial image closer to the clean image. In some embodiments, the adversarial cross-modal attention distribution of the adversarial image is guided to be close to the noisy cross-modal attention distribution of the noisy image, thereby purifying the adversarial image.

In some embodiments, the noisy cross-modal attention distribution corresponding to the noisy image is calculated. The cross-modal attention distribution refers to an attention distribution of the LVLM when processing multimodal data. The noisy cross-modal attention distribution refers to how the LVLM focuses on the attention (or attention weight) of the noisy image in the noisy sample when generating a prediction result based on the noisy sample.

In some embodiments, the LVLM calculates attention weights of all visual tokens in the noisy image. Each visual token corresponds to one noisy image feature. The LVLM divides the noisy image into several regions. Each region corresponds to one regional image feature. Regional image features of a plurality of regions may be fused into at least one noisy image feature, or fused into at least one visual token. Each regional image feature corresponds to one visual token. Alternatively, a plurality of image features corresponding to a plurality of regions may be represented as one visual token. The attention weight represents the importance of each visual token to the generation of a prediction result by the LVLM. That is, the LVLM evaluates the extent to which each visual token affects the generation of the prediction result.

Exemplarily, a task of the LVLM is to answer a question in the noisy image. A noisy image input of the LVLM is a car driving on a highway, and a text input of the LVLM is a question “What is the color of the car?”. When generating a prediction result, the LVLM calculates attention weights of all visual tokens in the noisy image. The attention weight represents the importance of each visual token to the current prediction result. That is, the LVLM evaluates the extent to which each visual token affects the generation of the prediction result. In some embodiments, the LVLM may focus primarily on a visual token representing a car part in the noisy image.

Operation 240: Determine a second correlation between at least one adversarial image feature of the adversarial image and the at least one text feature of the text.

In other words, the adversarial cross-modal attention distribution corresponding to the adversarial image is calculated. The adversarial cross-modal attention distribution is configured for describing attention distributions of the adversarial image and the text.

A calculation manner of the adversarial cross-modal attention distribution may refer to a calculation manner of the noisy cross-modal attention distribution. Details are not described in this embodiment of this application again.

Operation 250: Add second noise to the adversarial image based on the first correlation and the second correlation to purify the adversarial image to obtain a purified image.

The purified image is an image obtained after performing a second perturbation on the adversarial image. The second noise refers to random noise added to the adversarial image. The second noise is randomly generated or generated according to a rule, to perturb a pixel value of the adversarial image. In some embodiments, the second noise may be Gaussian noise, uniform noise, or other types of random noise.

In some embodiments, the noisy cross-modal attention distribution (i.e., the first correlation) of the noisy image is used as a target, to guide the adversarial cross-modal attention distribution (i.e., the second correlation) of the adversarial image to be close to the noisy cross-modal attention distribution (i.e., the first correlation) corresponding to the noisy image.

In some embodiments, the second correlation may be guided to be close to the first correlation by continuously adding random noise to the adversarial image, thereby generating the purified image. In some embodiments, the random noise added to the adversarial image is a noise value obtained through random sampling in a uniformly distributed interval range. Minimizing a difference between the first correlation and the second correlation is used as an optimization target, and the second noise is added to the adversarial image to generate the purified image.

In some embodiments, the LVLM may obtain a correct prediction result based on the purified image.

With reference to the clean image, a perturbation degree of the purified image relative to the clean image may be greater than a perturbation degree of the adversarial image relative to the clean image. The LVLM obtains an incorrect prediction result based on the adversarial image, but may obtain a correct result based on the purified image. Although the purified image may be noisier visually, a purified cross-modal attention distribution (i.e., a correlation between at least one purified image feature of the purified image and at least one text feature of the text) of the purified image may be closer to the clean cross-modal attention distribution (i.e., a correlation between at least one clean image feature of the clean image and the at least one text feature of the text) of the clean image. The second noise added to the purified image adjusts the attention distribution of the LVLM, enhancing the focus of the LVLM on features related to the prediction task in the purified image. Therefore, a prediction result of the LVLM for the purified image is closer to that for the clean image.

In some embodiments, the clean sample includes a clean image and text. The method further includes: determining a third correlation between at least one clean image feature of the clean image and at least one text feature of the text, the first correlation being closer to the third correlation than the second correlation.

In other words, the noisy cross-modal attention distribution (i.e., the first correlation) is closer to the clean cross-modal attention distribution (i.e., the third correlation) than the adversarial cross-modal attention distribution (i.e., the second correlation). Therefore, the noisy cross-modal attention distribution of the noisy image is used as an optimization target, and random noise is added to the adversarial image, so that the adversarial cross-modal attention distribution of the adversarial image is close to the noisy cross-modal attention distribution of the noisy image, to complete purification of the adversarial image and obtain the purified image.

A calculation manner of the third correlation may refer to a calculation manner of the first correlation and the second correlation. Details are not described in this application again.

In summary, according to the method provided in this embodiment, the LVLM may generate incorrect predictions based on the adversarial sample. A purification operation is performed on the adversarial image in the adversarial sample to obtain the purified image, so as to obtain the purified sample. Specifically, the noisy image is obtained by performing random noise addition on the adversarial image. Since the noisy cross-modal attention distribution (i.e., the first correlation between the at least one noisy image feature of the noisy image and the at least one text feature of the text) of the noisy image is very close to the cross-modal attention distribution (i.e., the correlation between at least one clean image feature of the clean image and at least one text feature of the text) corresponding to the clean image, the noisy cross-modal attention distribution of the noisy image is used as an optimization target, and random noise is added to the adversarial image, so that the adversarial cross-modal attention distribution (i.e., the second correlation between the at least one adversarial image feature of the adversarial image and the at least one text feature of the text) of the adversarial image is close to the noisy cross-modal attention distribution of the noisy image, to complete purification of the adversarial image and obtain the purified image. Further, in this application, with guidance of the cross-modal attention distribution, the adversarial image is purified by adding noise to the adversarial sample. The LVLM may obtain correct predictions based on the purified image (or purified sample), and this purification manner enhances the robustness of the LVLM. Further, the manner of guiding the addition of noise to the adversarial image by taking the cross-modal attention distribution as an estimation direction not only processes the adversarial image, but also optimizes the cross-modal attention distribution itself. Such optimization enables the attention distribution to more accurately focus on key information in an image, thereby improving the accuracy of prediction results outputted by the LVLM.

### Calculate a Cross-Modal Attention Distribution Corresponding to a Noisy Image

In some embodiments, compared with the adversarial cross-modal attention distribution of the adversarial image, the noisy cross-modal attention distribution of the noisy image is closer to the clean cross-modal attention distribution of the clean image. In some embodiments, the adversarial cross-modal attention distribution of the adversarial image is guided to be close to the noisy cross-modal attention distribution of the noisy image, thereby purifying the adversarial image.

In some embodiments, the noisy cross-modal attention distribution corresponding to the noisy image is calculated through the LVLM. Certainly, the noisy cross-modal attention distribution corresponding to the noisy image may alternatively be calculated through another model or a model similar to the LVLM. This is not limited in this embodiment of this application.

A calculation process of the noisy cross-modal attention distribution is described below using an example in which the noisy cross-modal attention distribution is calculated through the LVLM.

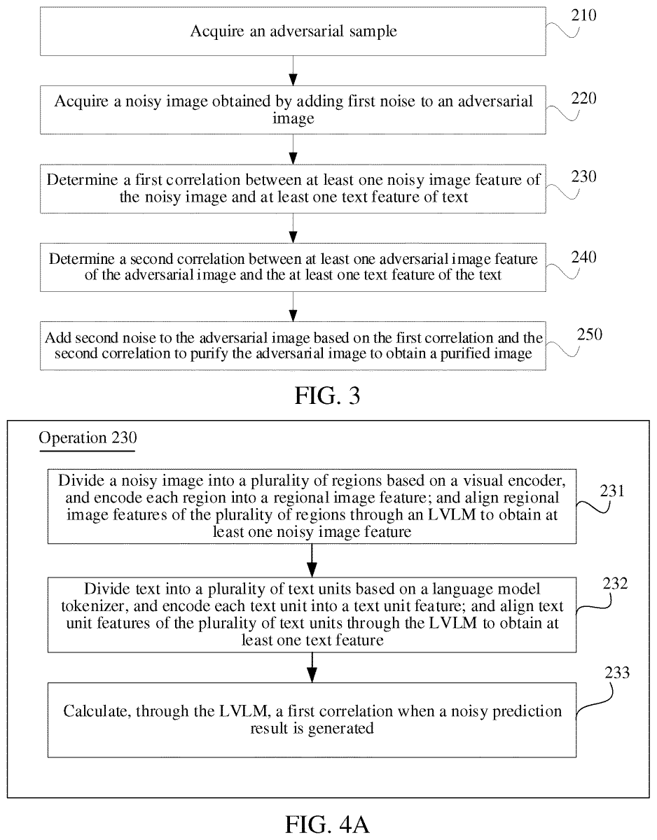

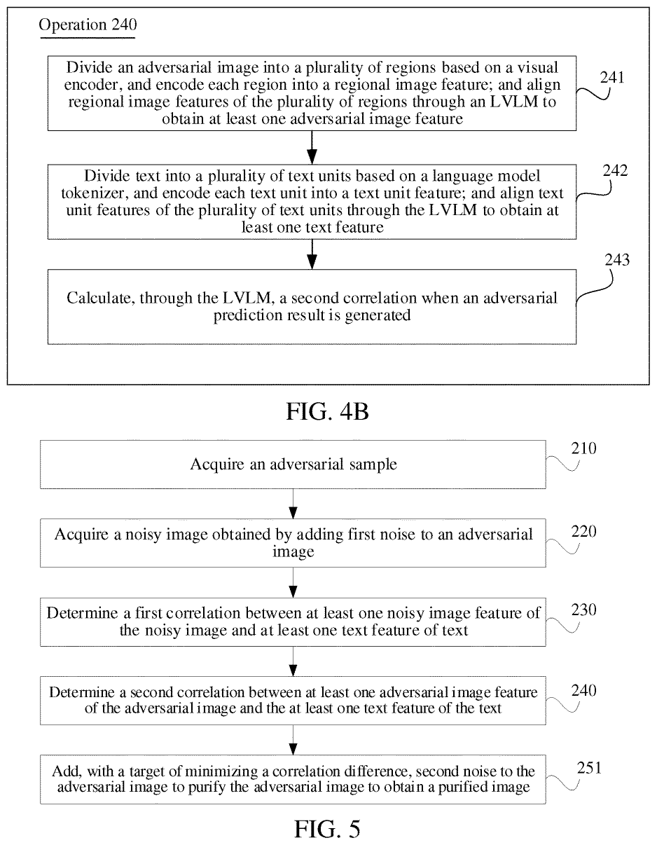

FIG. 4A is a flowchart of a sample purification method according to an exemplary embodiment of this application. Operation 230 may be replaced with operation 231, operation 232, and operation 233.

Operation 231: Divide the noisy image into a plurality of regions based on the visual encoder, and encode each region into a regional image feature; and align regional image features of the plurality of regions through the LVLM to obtain the at least one noisy image feature.

In some embodiments, the LVLM includes a visual encoder. The visual encoder is configured to extract a feature vector from the noisy image and encode the noisy image into regional image features (or referred to as visual features) of a plurality of regions. In some embodiments, the visual encoder receives the noisy image as an input and segments the noisy image into several regions. The regions may have a same size. Then, feature extraction is performed on an image block of each region, and the image block of each region may be encoded into an image feature (i.e., the regional image feature). In some embodiments, a plurality of regional image features are aligned through a language alignment module in the LVLM to obtain at least one noisy image feature. Each noisy image feature corresponds to one visual token. In other words, each visual token is used for at least one noisy image feature. Each visual token or noisy image feature may be a fused representation of several regional image features. For example, one region of the noisy image corresponds to one regional image feature, and one visual token may be a feature representation obtained after fusing several image features. Exemplarily, the visual encoder in the LVLM divides the noisy image into 16*16=256 regions and extracts 256 image features. The language alignment module processes the noisy image into 32 visual tokens, and each visual token may be a fused representation of 256 image features.

In a possible implementation, one regional image feature may be regarded as one visual token or one noisy image feature of the noisy image, and each visual token is configured for indicating one regional image feature of the noisy image. Alternatively, the plurality of regional image features may be regarded as one visual token or one noisy image feature of the noisy image, and each visual token is configured for indicating image features of the plurality of regions of the noisy image. For example, the noisy image is divided into 16×16 regions, and each region corresponds to one regional image feature. The LVLM obtains 32 visual tokens after processing the noisy image. Each visual token may be a fused representation of image features of all regions.

Description is provided below using an example in which one visual token indicates the image feature of one region of the image.

Exemplarily, it is assumed that there is a noisy image. The noisy image shows a man hitting a ball on a lawn. The noisy image is inputted to the LVLM, and the visual encoder in the LVLM segments the noisy image into several regions of a fixed size, for example, divides the noisy image into 32 regions. In some embodiments, for each region, the visual encoder extracts the feature of the region to obtain the image feature. The image feature of each region is encoded into a visual token, and each visual token represents visual information of a corresponding region in the noisy image. For example, a region 1 represents a lawn in the noisy image, and a visual token 1 is configured for indicating an image feature of a part representing the lawn in the noisy image. A region 2 represents the lawn and the man's feet in the noisy image, and a visual token 2 is configured for indicating image features of parts representing the lawn and the man's feet in the noisy image. A region 3 represents the man's head in the noisy image, and a visual token 3 is configured for indicating an image feature of a part representing the man's head in the noisy image. A region 4 represents the man's arm and a club in the noisy image, and a visual token 4 is configured for indicating image features of parts representing the man's arm and the club in the noisy image. A region 5 represents a ball in the noisy image, and a visual token 5 is configured for indicating an image feature of a part representing the ball in the noisy image. A region 6 represents the bottom of the club and the lawn in the noisy image, and a visual token 6 is configured for indicating image features of parts representing the bottom of the club and the lawn in the noisy image, and so on.

Operation 232: Divide the text into a plurality of text units based on the language model tokenizer, and encode each text unit into a text unit feature; and align text unit features of the plurality of text units through the LVLM to obtain the at least one text feature.

In some embodiments, the LVLM includes a language model tokenizer. The language model tokenizer is configured to extract a feature vector from the text and encode the text into text unit features of a plurality of text units. In some embodiments, the language model tokenizer receives the text as an input and decomposes the inputted text into smaller text units (i.e., subwords). In some embodiments, the text unit includes a word, a subword, or a character string.

The process of obtaining the text feature is described below using an example in which the text is decomposed into several subwords.

In some embodiments, each subword may be encoded through the language model tokenizer to obtain a subword feature (i.e., a text unit feature, which may alternatively be understood as a feature vector) of the subword. Then, each subword feature is used as a text feature, or a plurality of subword features is used as a text feature.

In some embodiments, each subword may be encoded through the language model tokenizer to obtain the subword feature (i.e., the text unit feature, which may alternatively be understood as a feature vector) of the subword. In addition, the LVLM may further reserve sequence information of each subword in the text, and add positional encoding to the subword feature of each subword to obtain a new subword feature. The positional encoding is a value calculated according to a position of the subword in the text. Then, each new subword feature is used as a text feature, or a plurality of new subword features are used as a text feature.

Description is provided below using an example in which one language token indicates a text feature of one subword of the text.

Exemplarily, it is assumed that text for the noisy image is a question description, and the question description indicated by the text is “what is the man doing?”. The text is inputted to the LVLM, and the language model tokenizer in the LVLM decomposes the text into several subwords, for example, decomposes “what is this man doing?” into the following subwords: [“the”, “man”, “is”, “doing”, “what”, and “?”]. For each subword, the language model tokenizer extracts a corresponding feature vector. To reserve the sequence information of the subword in the text, positional encoding may be added to the feature vector of each subword. The positional encoding is a value calculated according to the position of the subword in the text. The language alignment module in the LVLM aligns feature vectors and positional encoding of the subwords to generate language tokens. Each language token represents a text feature of a subword in a corresponding region in the text. For example, a subword 1 represents “the” in the text, and a language token 1 is configured for indicating a text feature of the subword “the”. A subword 2 represents “man” in the text, and a language token 2 is configured for indicating a text feature of the subword “man”. A subword 3 represents “is” in the text, and a language token 3 is configured for indicating a text feature of the subword “is”. A subword 4 represents “doing” in the text, and a language token 4 is configured for indicating a text feature of the subword “doing”. A subword 5 represents “what” in the text, and a language token 5 is configured for indicating a text feature of the subword “what”, and so on.

Operation 233: Calculate, through the LVLM, the first correlation when a noisy prediction result is generated.

The noisy prediction result is a prediction result obtained after the LVLM fuses at least one visual token and at least one language token of the noisy image. Each visual token corresponds to one noisy image feature. Each language token corresponds to one text feature.

In some embodiments, all visual tokens and corresponding attention weights in the noisy image are integrated to form an overall representation of the noisy image. The LVLM generates the noisy prediction result corresponding to the noisy image according to descriptions of the integrated visual token and the corresponding language token. The noisy prediction result is a prediction result of the LVLM for the integrated visual token (noisy image) according to the language token (the question description corresponding to the text).

In some embodiments, when generating the noisy prediction result based on the noisy image, the LVLM calculates attention weights of all visual tokens in the noisy image. The attention weight represents the importance of each visual token to the noisy prediction result. That is, the LVLM evaluates the extent to which each visual token affects the generation of the noisy prediction result. In some embodiments, when generating the noisy prediction result, the LVLM focuses primarily on a visual token whose attention weight is greater than a first preset weight threshold in the noisy image, and ignores a visual token whose attention weight is less than a second preset weight threshold in the noisy image.

In some embodiments, the noisy cross-modal attention distribution may be represented through a noisy cross-modal attention distribution map. That is, the noisy cross-modal attention distribution map is a visual representation of the noisy cross-modal attention distribution. The noisy cross-modal attention distribution map has several dimensions. For example, the noisy cross-modal attention distribution map may represent a quantity of layers of the LVLM and a quantity of visual tokens. The noisy cross-modal attention distribution map may more clearly represent the attention distribution of the visual token in the noisy image. In some embodiments, in the noisy cross-modal attention distribution map, a visual token whose attention weight is greater than the first preset weight threshold in the noisy image may be represented in a first form, a visual token whose attention weight is less than the second preset weight threshold in the noisy image may be represented in a second form, and a visual token whose attention weight is less than the first preset weight threshold and greater than the second preset weight threshold in the noisy image may be represented in a third form. In some embodiments, visual saliency of the first form is higher than that of the third form, and visual saliency of the third form is higher than that of the second form. This is not limited in this application.

Exemplarily, it is assumed that a noisy image is inputted to the LVLM, and the noisy image shows a man hitting a ball on a lawn. Text corresponding to the noisy image is a question description, and the question description indicated by the text is “what is the man doing?”. For example, a region 1 in the noisy image represents a lawn. A region 2 in the noisy image represents the lawn and the man's feet. A region 3 in the noisy image represents the man's head. A region 4 in the noisy image represents the man's arm and a club. A region 5 in the noisy image represents a ball. A region 6 in the noisy image represents the sky and the like. A subword 1 of the text represents “the”. A subword 2 of the text represents “man”. A subword 3 of the text represents “is”. A subword 4 of the text represents “doing”. A subword 5 of the text represents “what” and the like. When generating the noisy prediction result for the noisy image, the LVLM calculates the attention weight of each subword in the text for each region (visual token) in the noisy image. This reflects a degree of attention the LVLM pays to the visual token when generating the noisy prediction result. In some embodiments, when generating the noisy prediction result, the LVLM may focus on a region having a relatively high attention weight in the noisy image. For example, an attention weight of a visual token corresponding to the region 1 in the noisy image is 0.05, an attention weight of a visual token corresponding to the region 2 in the noisy image is 0.1, an attention weight of a visual token corresponding to the region 3 in the noisy image is 0.1, an attention weight of a visual token corresponding to the region 4 in the noisy image is 0.3, an attention weight of a visual token corresponding to the region 5 in the noisy image is 0.2, an attention weight of a visual token corresponding to the region 6 in the noisy image is 0.01, and so on. For example, when generating the noisy prediction result, the LVLM focuses primarily on “the man's arm and the club” indicated by the region 4 and “the ball” indicated by the region 5 in the noisy image, and ignores “the sky” indicated by the region 6 in the noisy image. The LVLM obtains, with reference to the question description corresponding to the text, that the noisy prediction result is “throw a ball”, “hit a ball”, or another result.

The structure of the LVLM is not limited in this embodiment of this application. For example, the visual encoder and the language model tokenizer may be replaced with an integral model or module to implement functions of the visual encoder and the language model tokenizer.

In summary, according to the method provided in this embodiment of this application, the noisy image is encoded into several regional image features through the visual encoder, and each visual token represents image features (one or more groups of feature vectors) of one or more regions of the image. This decomposition may simplify complex information of the noisy image into a group of structured features, helping the LVLM to process and understand different parts of the noisy image. The text is encoded into several groups of text unit features, i.e., feature vectors, through the language model tokenizer. Each language token represents one or more subwords of the text. This decomposition converts the text into structured features, helping the LVLM to understand the semantics of the text. The noisy cross-modal attention distribution is calculated through the LVLM, allowing the LVLM to focus on the correlation between the noisy image and the text when generating the noisy prediction result. This helps the LVLM to determine which image regions in the noisy image are most relevant to which subwords in the text, so as to more accurately understand and explain a relationship between the image and the text, thereby generating a relatively accurate and relevant prediction result.

### Calculate a Cross-Modal Attention Distribution Corresponding to an Adversarial Image

In some embodiments, the adversarial cross-modal attention distribution of the adversarial image is guided to be close to the noisy cross-modal attention distribution of the noisy image, thereby purifying the adversarial image.

In some embodiments, the adversarial cross-modal attention distribution corresponding to the adversarial image is calculated through the LVLM. Certainly, the adversarial cross-modal attention distribution corresponding to the adversarial image may alternatively be calculated through another model or a model similar to the LVLM. This is not limited in this embodiment of this application.

A calculation process of the adversarial cross-modal attention distribution is described below using an example in which the adversarial cross-modal attention distribution is calculated through the LVLM.

FIG. 4B is a flowchart of a sample purification method according to an exemplary embodiment of this application. Operation 240 may be replaced with operation 241, operation 242, and operation 243.

Operation 241: Divide the adversarial image into a plurality of regions based on the visual encoder, and encode each region into a regional image feature; and align regional image features of the plurality of regions through the LVLM to obtain the at least one adversarial image feature.

In some embodiments, the LVLM includes a visual encoder. The visual encoder is configured to extract a feature vector from the adversarial image and encode the adversarial image into regional image features (or referred to as visual features) of a plurality of regions. In some embodiments, the visual encoder receives the adversarial image as an input and segments the adversarial image into several regions. The regions may have a same size. Then, feature extraction is performed on an image block of each region, and the image block of each region may be encoded into an image feature (i.e., the regional image feature). In some embodiments, a plurality of regional image features are aligned through a language alignment module in the LVLM to obtain at least one adversarial image feature. Each adversarial image feature corresponds to one visual token. In other words, each visual token is used for at least one adversarial image feature. Each visual token or adversarial image feature may be a fused representation of several regional image features. For example, one region of the adversarial image corresponds to one regional image feature, and one visual token may be a feature representation obtained after fusing several image features. Exemplarily, the visual encoder in the LVLM divides the adversarial image into 16*16=256 regions and extracts 256 image features. The language alignment module processes the adversarial image into 32 visual tokens, and each visual token may be a fused representation of 256 image features.

In a possible implementation, one regional image feature may be regarded as one visual token or one adversarial image feature of the adversarial image, and each visual token is configured for indicating one regional image feature of the adversarial image. Alternatively, the plurality of regional image features may be regarded as one visual token or one adversarial image feature of the adversarial image, and each visual token is configured for indicating image features of the plurality of regions of the adversarial image. For example, the adversarial image is divided into 16×16 regions, and each region corresponds to one regional image feature. The LVLM obtains 32 visual tokens after processing the adversarial image. Each visual token may be a fused representation of image features of all regions.

Operation 242: Divide the text into a plurality of text units based on the language model tokenizer, and encode each text unit into a text unit feature; and align text unit features of the plurality of text units through the LVLM to obtain the at least one text feature.

Explanations about operation 242 may refer to operation 232. Details are not described in this embodiment of this application again.

Operation 243: Calculate, through the LVLM, the second correlation when an adversarial prediction result is generated.

The adversarial prediction result is a prediction result obtained after the LVLM fuses at least one visual token and at least one language token of the adversarial image. Each visual token corresponds to one adversarial image feature. Each language token corresponds to one text feature.

The adversarial prediction result is a prediction result obtained after the LVLM fuses at least one visual token and at least one language token of the adversarial image.

In some embodiments, all visual tokens and corresponding attention weights in the adversarial image are integrated to form an overall representation of the adversarial image. The LVLM generates the adversarial prediction result corresponding to the adversarial image according to descriptions of the integrated visual token and the corresponding language token. The adversarial prediction result is a prediction result of the LVLM for the integrated visual token (adversarial image) according to the language token (the question description corresponding to the text).

In some embodiments, when generating the adversarial prediction result based on the adversarial image, the LVLM calculates attention weights of all visual tokens in the adversarial image. The attention weight represents the importance of each visual token to the adversarial prediction result. That is, the LVLM evaluates the extent to which each visual token affects the generation of the adversarial prediction result. In some embodiments, when generating the adversarial prediction result, the LVLM focuses primarily on a visual token whose attention weight is greater than a first preset weight threshold in the adversarial image, and ignores a visual token whose attention weight is less than a second preset weight threshold in the adversarial image.

In some embodiments, the adversarial cross-modal attention distribution may be represented through an adversarial cross-modal attention distribution map. That is, the adversarial cross-modal attention distribution map is a visual representation of the adversarial cross-modal attention distribution. The adversarial cross-modal attention distribution map has several dimensions. For example, the adversarial cross-modal attention distribution map may represent a quantity of layers of the LVLM and a quantity of visual tokens. The adversarial cross-modal attention distribution map may more clearly represent the attention distribution of the visual token in the adversarial image. In some embodiments, in the adversarial cross-modal attention distribution map, a visual token whose attention weight is greater than the first preset weight threshold in the adversarial image may be represented in a first form, a visual token whose attention weight is less than the second preset weight threshold in the adversarial image may be represented in a second form, and a visual token whose attention weight is less than the first preset weight threshold and greater than the second preset weight threshold in the adversarial image may be represented in a third form. In some embodiments, visual saliency of the first form is higher than that of the third form, and visual saliency of the third form is higher than that of the second form. This is not limited in this application.

In summary, according to the method provided in this embodiment of this application, the adversarial image is encoded into several regional image features through the visual encoder, and each visual token represents image features (one or more groups of feature vectors) of one or more regions of the image. This decomposition may simplify complex information of the adversarial image into a group of structured features, helping the LVLM to process and understand different parts of the adversarial image. The text is encoded into several groups of text unit features, i.e., feature vectors, through the language model tokenizer. Each language token represents one or more subwords of the text. This decomposition converts the text into structured features, helping the LVLM to understand the semantics of the text. The adversarial cross-modal attention distribution is calculated through the LVLM, allowing the LVLM to focus on the correlation between the adversarial image and the text when generating the adversarial prediction result. This helps the LVLM to determine which image regions in the adversarial image are most relevant to which subwords in the text, so as to more accurately understand and explain a relationship between the image and the text, thereby generating a relatively accurate and relevant prediction result.

Add, with a Target of Minimizing a Correlation Difference, Second Noise to An Adversarial Image

In some embodiments, the first correlation is used as a target to guide the second correlation to be close to the first correlation. In some embodiments, with a target of minimizing a difference value between the first correlation and the second correlation, the second noise is added to the adversarial image to generate a purified image.

FIG. 5 is a flowchart of a sample purification method according to an exemplary embodiment of this application. Operation 250 may be replaced with operation 251.

Operation 251: Add, with a target of minimizing a correlation difference, the second noise to the adversarial image to purify the adversarial image to obtain the purified image.

The correlation difference is a difference between the first correlation and the second correlation. The correlation difference may alternatively be referred to as an attention difference or an attention value, which represents a difference between the noisy cross-modal attention distribution and the adversarial cross-modal attention distribution.

In some embodiments, the noisy cross-modal attention distribution is a cross-modal attention distribution corresponding to the noisy image, and is configured for describing attention distributions of the noisy image and the text. The adversarial cross-modal attention distribution is a cross-modal attention distribution corresponding to the adversarial image, and is configured for describing attention distributions of the adversarial image and the text. In some embodiments, the noisy cross-modal attention distribution corresponding to the noisy image is calculated based on the visual token and the language token in the noisy image, and the adversarial cross-modal attention distribution corresponding to the adversarial image is calculated based on the visual token and the language token in the adversarial image.

In some embodiments, an attention difference value may be obtained based on the adversarial cross-modal attention distribution and the noisy cross-modal attention distribution. The attention difference value is a difference between the noisy cross-modal attention distribution and the adversarial cross-modal attention distribution. In some embodiments, with a target of minimizing the attention difference value, the second noise is added to the adversarial image.

In some embodiments, the attention difference value may be represented as:

$$Δ A = A ( {x}_{i}^{′} , {x}_{t} , f ) - A ( R ( {x}_{i}^{′} , {α}_{∞} ) , {x}_{t} , f ) ,$$

where ΔA represents the attention difference value,

$${x}_{i}^{′}$$

represents the adversarial image,

$$R ( {x}_{i}^{′} , {α}_{∞} )$$

represents the noisy image, i.e., a noisy image obtained by adding the first noise α_{∞} to the adversarial image

$${x}_{i}^{′} ,$$

xₜ represents the text, f represents the LVLM,

$$A ( {x}_{i}^{′} , {x}_{t} , f )$$

represents the adversarial cross-modal attention distribution corresponding to the adversarial image, and

$$A ( R ( {x}_{i}^{′} , {α}_{∞} ) , {x}_{t} , f )$$

represents the noisy cross-modal attention distribution corresponding to the noisy image.

In some embodiments, the noisy cross-modal attention distribution corresponding to the noisy image is close to a clean cross-modal attention distribution corresponding to a clean image. Therefore, the noisy cross-modal attention distribution may be regarded as a reference point for purification. In some embodiments, the adversarial image is purified by guiding the adversarial cross-modal attention distribution to be close to the noisy cross-modal attention distribution, that is, minimizing the difference (attention difference value) between the adversarial cross-modal attention distribution and the noisy cross-modal attention distribution. In a possible implementation, the attention distribution (or understood as an attention weight) of the visual token in the adversarial cross-modal attention distribution may be affected by adding the second noise to the adversarial image, thereby purifying the adversarial image and obtaining the purified image.

In some embodiments, the purified image may be represented as:

$${x}_{i}^{p} = {x}_{i}^{′} - β \times sign ( {∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2} ) , β ∼ U [ 0 , {β}_{∞} ] ,$$

where

$${x}_{i}^{p}$$

represents the purified image,

$${x}_{i}^{′}$$

represents the adversarial image,

$$R ( {x}_{i}^{′} , {α}_{∞} )$$

represents the noisy image, xₜ represents the text, f represents the LVLM, and β represents the second noise. That is, the second noise is determined based on a second noise value obtained through pseudo-random sampling within a second distribution interval [0, β_{∞}]. The second distribution interval [0, β_{∞}] is a uniformly distributed interval range.

$$A ( {x}_{i}^{′} , {x}_{t} , f )$$

represents the adversarial cross-modal attention distribution corresponding to the adversarial image,

$$A ( R ( {x}_{i}^{′} , {α}_{∞} ) , {x}_{t} , f )$$

represents the noisy cross-modal attention distribution corresponding to the noisy image,

$$A ( {x}_{i}^{′} , {x}_{t} , f ) - A ( R ( {x}_{i}^{′} , {α}_{∞} ) , {x}_{t} , f )$$

represents the attention difference value, and

$${∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2}$$

represents minimizing the attention difference value.

In some embodiments, with a target of minimizing the attention difference value, the second noise is added to the adversarial image to obtain the purified image. In some embodiments, the second noise added to the adversarial image is uniform noise.

In some embodiments, an image obtained after adding the second noise to the adversarial image is inputted to the LVLM for prediction. In some embodiments, whether the image is a purified image is determined based on a prediction result of the LVLM for the image obtained after adding the second noise. If the prediction result of the LVLM for the image is a correct prediction result (which is the same as a prediction result of the clean image), it may be determined that the image is a purified image. If the prediction result of the LVLM for the image is an incorrect prediction result (different from the prediction result of the clean image), random noise continues to be added to the adversarial image based on the noisy cross-modal attention distribution to adjust the attention distribution of the visual token in the adversarial image until the prediction result of the LVLM is a correct prediction result.

In a possible implementation, a preset question answering score threshold is set in the LVLM, and whether the prediction result of the LVLM is a correct prediction result is determined based on the preset question answering score threshold. In some embodiments, when a question answering score of the LVLM for the image obtained after adding the second noise to the adversarial image is greater than the preset question answering score threshold, the prediction result of the LVLM is a correct prediction result. In this case, the image is a purified image. When the question answering score of the LVLM for the image obtained after adding the second noise to the adversarial image is less than the preset question answering score threshold, the prediction result of the LVLM is an incorrect prediction result. Then, random noise continues to be added to the adversarial image based on the noisy cross-modal attention distribution until the LVLM outputs a correct prediction result. A specific value of the preset question answering score threshold is not limited in this application.

In some implementations, adding the second noise to the adversarial image based on the noisy cross-modal attention distribution and the adversarial cross-modal attention distribution to purify the adversarial image to obtain the purified image includes: adding, with a target of minimizing a target difference value, the second noise to the adversarial image to obtain the purified image. The target difference value is a product or a sum of the attention difference value and a preset coefficient, and the attention difference value is a difference between the noisy cross-modal attention distribution and the adversarial cross-modal attention distribution. In summary, during the optimization target design, the adversarial cross-modal attention distribution of the adversarial image needs to be close to the noisy cross-modal attention distribution of the noisy image. The optimization target is not limited in this embodiment of this application.

In this embodiment of this application, the adversarial cross-modal attention distribution corresponding to the adversarial image and the noisy cross-modal attention distribution corresponding to the noisy image are calculated, and the second noise is added to the adversarial image with the target of minimizing the difference (attention difference value) between the adversarial cross-modal attention distribution and the noisy cross-modal attention distribution. This guidance manner, which uses the cross-modal attention distribution as an estimation direction, may obtain the purified image. This manner not only processes noise of the adversarial image, but also optimizes the cross-modal attention distribution mechanism itself, so that the attention mechanism can focus on key information in the adversarial image more accurately, and ignores irrelevant or interference information, thereby improving the accuracy and efficiency of cross-modal tasks.

### Control a Noise Direction of Adding Second Noise to an Adversarial Image

In some embodiments, with a target of minimizing a difference value between the adversarial cross-modal attention distribution and the noisy cross-modal attention distribution, the second noise is added to the adversarial image to generate the purified image. In some embodiments, the purified image is generated by controlling the noise direction of adding the second noise to the adversarial image. In other words, with a target of minimizing a correlation difference, the second noise is added to the adversarial image to generate the purified image. In some embodiments, the purified image is generated by controlling the noise direction of adding the second noise to the adversarial image.

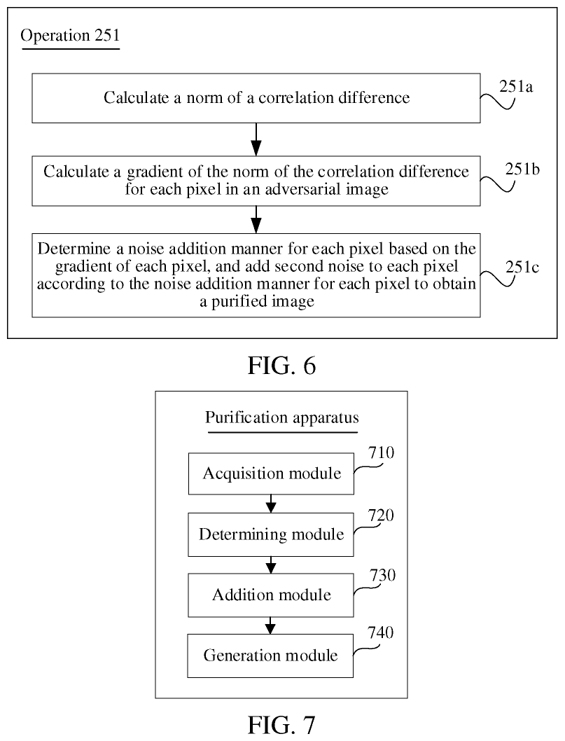

FIG. 6 is a flowchart of a sample purification method according to an exemplary embodiment of this application. Operation 251 may be replaced with operation 251a, operation 251b, and operation 251c.

Operation 251a: Calculate a norm of the correlation difference.

The norm is configured for measuring a distance between the first correlation and the second correlation.

In some embodiments, the first correlation and the second correlation may each be represented as a matrix, and the norm is configured for measuring a spatial distance between the first correlation and the second correlation.

In some embodiments, the norm is an L₂ norm (Euclidean norm), which is a square root of a square sum of a vector (attention matrix) and is configured for measuring the difference between the first correlation and the second correlation. A norm value corresponding to the norm provides a quantitative metric. In some embodiments, a relatively small norm value indicates that the first correlation and the second correlation are similar, and a relatively large norm value indicates that the first correlation and the second correlation are significantly different.

In some embodiments, calculating the norm of the correlation difference may alternatively be understood as calculating a loss function (L₂ norm distance between correlation differences) of the correlation difference. In some embodiments, the norm of the correlation difference may be represented as:

$$Y = {‖ A ( {x}_{i}^{′} , {x}_{t} , f ) - A ( R ( {x}_{i}^{′} , {α}_{∞} ) , {x}_{t} , f ) ‖}_{2} ,$$

where

$${x}_{i}^{′}$$

represents the adversarial image,

$$R ( {x}_{i}^{′} , {α}_{∞} )$$

represents the noisy image, xₜ represents the text, f represents the LVLM,

$$A ( {x}_{i}^{′} , {x}_{t} , f )$$

represents the adversarial cross-modal attention distribution corresponding to the adversarial image, i.e., the second correlation,

$$A ( R ( {x}_{i}^{′} , {α}_{∞} ) , {x}_{t} , f )$$

represents the noisy cross-modal attention distribution corresponding to the noisy image, i.e., the first correlation,

$$A ( {x}_{i}^{′} , {x}_{t} , f ) - A ( R ( {x}_{i}^{′} , {α}_{∞} ) , {x}_{t} , f )$$

represents the correlation difference, and

$${‖ A ( {x}_{i}^{′} , {x}_{t} , f ) - A ( R ( {x}_{i}^{′} , {α}_{∞} ) , {x}_{t} , f ) ‖}_{2}$$

represents the norm of the correlation difference.

Operation 251b: Calculate a gradient of the norm of the correlation difference for each pixel in the adversarial image.

In some embodiments, the norm of the correlation difference may be regarded as a loss function of the correlation difference. The gradient of the norm of the correlation difference for each pixel in the adversarial image may be understood as a gradient of the loss function for each pixel in the adversarial image. In some embodiments, the gradient is configured for indicating a direction in which the loss function decreases fastest. That is, the gradient is configured for indicating how to add the second noise to minimize the correlation difference.

In some embodiments, the gradient may be represented as:

$$g = {∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2} ,$$

where g represents the gradient,

$$A ( {x}_{i}^{′} , {x}_{t} , f )$$

represents the adversarial cross-modal attention distribution corresponding to the adversarial image,

$$A ( R ( {x}_{i}^{′} , {α}_{∞} ) , {x}_{t} , f )$$

represents the noisy cross-modal attention distribution corresponding to the noisy image, and

$${∇}_{{x}_{i}^{′}}$$

represents the gradient for the pixel in the adversarial image.

Operation 251c: Determine a noise addition manner for each pixel based on the gradient of each pixel, and add the second noise to each pixel according to the noise addition manner for each pixel to obtain the purified image.

In some embodiments, a gradient direction of the gradient is determined based on a sign function. The gradient direction is configured for indicating a noise addition direction of adding the second noise to the adversarial image. That is, the second noise is added to the pixel in the adversarial image, and the pixel in the adversarial image is adjusted toward the gradient direction to reduce the correlation difference.

In some embodiments, determining a noise addition direction of each pixel based on the gradient of each pixel in the adversarial image may alternatively be understood as determining the noise addition manner for each pixel based on the gradient of each pixel in the adversarial image. The noise addition direction is the same as the gradient direction. That is, the noise addition manner refers to adding the second noise to the pixel of the adversarial image along the gradient direction. In some embodiments, the noise addition manner includes increasing a pixel value of the pixel of the adversarial image; decreasing the pixel value of the pixel of the adversarial image; or keeping the pixel value of the pixel of the adversarial image unchanged (a case in which the pixel value is unchanged almost does not exist, and basically, the pixel value of each pixel of the adversarial image changes).

In some embodiments, determining the noise addition direction (or referred to as the noise addition manner for each pixel) of adding the second noise to the adversarial image based on the sign function may be represented as:

$$sign ( {∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2} ) ,$$

where

$$A ( {x}_{i}^{′} , {x}_{t} , f )$$

represents the adversarial cross-modal attention distribution corresponding to the adversarial image,

$$A ( R ( {x}_{i}^{′} , {α}_{∞} ) , {x}_{t} , f )$$

represents the noisy cross-modal attention distribution corresponding to the noisy image, sign(·) represents the sign function, and

$${∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2}$$

represents the gradient.

In some embodiments, the gradient is used as an input of the sign function. When the gradient is a positive value, that is, when a gradient of an i^{th} pixel in the adversarial image is a positive value, an output of the sign function is 1, indicating that a noise addition manner for the i^{th} pixel is a first noise addition manner. The first noise addition manner is configured for adding the second noise to a pixel value of the i^{th} pixel to increase the pixel value of the i^{th} pixel. When the gradient is a negative value, that is, when the gradient of the i^{th} pixel is a negative value, the output of the sign function is −1, indicating that the noise addition manner for the i^{th} pixel is a second noise addition manner. The second noise addition manner is configured for adding the second noise to the pixel value of the i^{th} pixel to decrease the pixel value of the i^{th} pixel. When the gradient is zero, that is, when the gradient of the i^{th} pixel in the adversarial image is zero, the output of the sign function is 0, indicating that the noise addition manner for the i^{th} pixel is keeping the pixel value unchanged. In some embodiments, the pixel value of the i^{th} pixel is kept unchanged (this case almost does not exist). The purified image is obtained based on the noise addition manner for each pixel in the adversarial image.

In this embodiment of this application, the gradient direction of the gradient is determined using the sign function. The gradient direction is configured for indicating the noise addition direction of adding the second noise to the adversarial image. That is, the noise addition manner for each pixel is determined based on the gradient. The gradient is adopted to guide pixel value adjustment, so that the adversarial image may be accurately purified. Processing on the gradient may be simplified using the sign function. The gradient is directly converted into a direction (increase or decrease) of pixel value adjustment, thereby simplifying a calculation process.

In summary, according to the method provided in this embodiment of this application, the difference between the first correlation and the second correlation may be quantitatively evaluated by calculating the norm of the correlation difference. The noise addition manner for each pixel is determined using the gradient of each pixel, so that the purification process is targeted. The noise addition manner for each pixel is determined based on the gradient of each pixel, so that adaptive adjustment may be achieved. The purified image obtained through the adaptive adjustment manner of each pixel in the adversarial image may significantly reduce the impact of adversarial perturbation, enhance the robustness and security of the LVLM, and improve its defense capability against the adversarial attack.

In some embodiments, the adding, with a target of minimizing a correlation difference, the second noise to the adversarial image to purify the adversarial image to obtain the purified image includes: calculating a minimum difference value of the correlation difference; calculating a gradient of a norm of the minimum correlation difference for each pixel in the adversarial image; and determining the noise addition manner for each pixel based on the gradient of each pixel, and adding the second noise to each pixel according to the noise addition manner for each pixel to obtain the purified image.

The correlation difference is actually a matrix, and the minimum correlation difference is a minimum element in the matrix.

The gradient calculation manner and the noise addition manner for each pixel may refer to the foregoing descriptions. Details are not described in this embodiment of this application again.

In some embodiments, the adding, with a target of minimizing a correlation difference, the second noise to the adversarial image to purify the adversarial image to obtain the purified image includes: calculating a maximum difference value of the correlation difference; calculating a gradient of a norm of the maximum correlation difference for each pixel in the adversarial image; and determining the noise addition manner for each pixel based on the gradient of each pixel, and adding the second noise to each pixel according to the noise addition manner for each pixel to obtain the purified image.

The correlation difference is actually a matrix, and the maximum correlation difference is a maximum element in the matrix.

The gradient calculation manner and the noise addition manner for each pixel may refer to the foregoing descriptions. Details are not described in this embodiment of this application again.

### Control the Noise Magnitude of Second Noise Added to an Adversarial Image at the Pixel Granularity

In some embodiments, the gradient of each pixel in the adversarial image is calculated. The gradient includes direction information and intensity information. The intensity information is configured for indicating an amplitude of pixel adjustment in the adversarial image.

The second noise corresponding to each pixel in the adversarial image is determined based on the intensity information of the gradient. The intensity information is configured for indicating a magnitude of the gradient of each pixel in the adversarial image.

In some embodiments, the adversarial image in the adversarial sample is divided at the pixel granularity, and second noise of different perturbation degrees (different noise magnitudes) is added at different pixel positions of the adversarial image based on the gradient direction. The intensity information of the gradient is configured for indicating the magnitude of the gradient of each pixel in the adversarial image. In some embodiments, a pixel having a relatively large gradient in the adversarial image shall be subjected to a large perturbation, that is, added with relatively large noise. A pixel having a relatively small gradient in the adversarial image shall be subjected to a relatively small perturbation, that is, added with relatively small noise.

In this embodiment of this application, the magnitude of the second noise added to each pixel in the adversarial image is determined through the intensity information of the gradient. The intensity information reflects the magnitude of the gradient and can better guide the addition of the second noise, making the noise addition process more accurate.

In some embodiments, a first gradient value and a second gradient value are acquired. The first gradient value is a maximum gradient value of all pixels in the adversarial image, and the second gradient value is a minimum gradient value of all pixels in the adversarial image. In some embodiments, a standard gradient value is obtained based on the maximum gradient value and the minimum gradient value. The standard gradient value is a gradient value obtained after normalizing the gradient. In some embodiments, the gradient is normalized to [0, 1].

In some embodiments, the gradient is represented as:

$$g = {∇}_{{x}_{i}^{′}} {‖ A ( {x}_{i}^{′} , {x}_{t} , f ) - A ( R ( {x}_{i}^{′} , {α}_{∞} ) , {x}_{t} , f ) ‖}_{2} ,$$

where g represents the gradient,

$$A ( {x}_{i}^{′} , {x}_{t} , f )$$

represents the adversarial cross-modal attention distribution corresponding to the adversarial image, and

$$A ( R ( {x}_{i}^{′} , {α}_{∞} ) , {x}_{t} , f )$$

represents the noisy cross-modal attention distribution corresponding to the noisy image.

In some embodiments, the standard gradient value is represented as:

$${g}_{norm} = ( g - {g}_{min} ) / ( {g}_{max} - {g}_{min} ) ,$$

where gₙₒᵣₘ represents the standard gradient value, gₘᵢₙ represents the first gradient value, i.e., the minimum gradient value, and gₘₐₓ represents the second gradient value, i.e., the maximum gradient value.

In some embodiments, since the standard gradient values vary significantly, the standard gradient value may be represented based on an average value of the standard gradient values. In some embodiments, a perturbation amplitude of the second noise is determined according to the standard gradient value and the average value of the standard gradient values. The perturbation amplitude includes a perturbation factor configured for determining a magnitude of the second noise. Based on the perturbation factor, the magnitude of the second noise added to each pixel in the adversarial image is determined. The magnitude of the second noise is positively correlated with the intensity information of the gradient. That is, a pixel having a relatively large gradient (relatively strong intensity information) in the adversarial image shall be subjected to a large perturbation, that is, added with relatively large second noise. A pixel having a relatively small gradient (relatively weak intensity information) in the adversarial image shall be subjected to a relatively small perturbation, that is, added with relatively small second noise.

In some embodiments, based on the perturbation factor, the magnitude of the second noise added to each pixel in the adversarial image is determined to obtain the purified image. The purified image may be represented as:

$${x}_{i}^{p} = {x}_{i}^{′} - {β}_{∞} \times max ( 0 , min ( {g}_{norm} / \overline{{g}_{norm}} , 1 ) ) \times sign ( g ) ,$$

where

$${x}_{i}^{p}$$

represents the purified image,

$${x}_{i}^{′}$$

represents the adversarial image, sign(g) is configured for indicating the noise addition direction (or referred to as the noise addition manner for each pixel) of adding the second noise to the adversarial image, gₙₒᵣₘ represents the standard gradient value, and g̅ₙ̅ₒ̅ᵣ̅ₘ̅ represents an average value of standard gradient values. The perturbation amplitude of the second noise may be determined based on max(0, min(gₙₒᵣₘ/g̅ₙ̅ₒ̅ᵣ̅ₘ̅, 1)). A value of max(0, min(gₙₒᵣₘ/g̅ₙ̅ₒ̅ᵣ̅ₘ̅, 1)) is a perturbation factor, and the perturbation factor is configured for determining the magnitude of the second noise β_{∞}. In some embodiments, 0 is a first normalized value, and 1 is a second normalized value. The perturbation factor is a maximum value of the first normalized value and a first value, the first value is a minimum value of the second normalized value and a second value, and the second value is a quotient of the standard gradient value and the average value of the standard gradient values. That is, the first value is min(gₙₒᵣₘ/g̅ₙ̅ₒ̅ᵣ̅ₘ̅, 1), and the second value is the quotient gₙₒᵣₘ/g̅ₙ̅ₒ̅ᵣ̅ₘ̅ of gₙₒᵣₘ and g̅ₙ̅ₒ̅ᵣ̅ₘ̅. In some embodiments, the perturbation factor is a value within the perturbation amplitude.

In some embodiments, the second noise is determined based on a product of the perturbation factor and the second noise value obtained through pseudo-random sampling within a second distribution interval. The second distribution interval is a uniformly distributed interval range.

In this embodiment of this application, the maximum gradient value and the minimum gradient value of all pixels in the adversarial image are acquired, and the gradient values are normalized to obtain the standard gradient value, so that gradient values of different scales can be uniformly processed. The perturbation amplitude of the second noise is determined according to the standard gradient value and the average value of the standard gradient values, so that the noise addition process is more flexible and adaptive. According to this adaptive adjustment manner, the magnitude of the added second noise can be properly determined according to the actual gradient situation. That is, a larger gradient indicates larger added second noise. This manner of adding the second noise to the adversarial image improves the purification effect.

In some embodiments, the magnitude of the second noise corresponding to each pixel in the adversarial image may alternatively be a preset magnitude. That is, the intensity information of the gradient is not required to determine the magnitude of the second noise.

A calculation manner of the standard gradient value is not limited in this embodiment of this application. For example, the standard gradient value is an average value of gradients of all pixels in the adversarial image.

### Training Process of LVLM

In some embodiments, an LVLM may be pre-trained, and a purified sample is inputted to the LVLM to obtain a question answering score for the LVLM. The question answering score is configured for indicating a correct probability that the purified sample belongs to a correct prediction result (correct category). In some embodiments, the question answering score is positively correlated with the purified cross-modal attention distribution of the purified sample.

In a possible implementation, a manner of training the LVLM is as follows.

In some embodiments, a purified sample data set is acquired. The purified sample data set is a set of samples for training the LVLM. The purified sample data set includes a plurality of purified samples. Each purified sample includes a purified image and text. The purified image is an image obtained through the method provided in the foregoing embodiments. A label corresponding to each purified sample is configured for indicating a category to which the purified image in the purified sample belongs. Then, the purified sample is inputted to the LVLM, and the LVLM encodes the purified image into an image feature and encodes the text into a text feature. In some embodiments, the LVLM fuses the image feature and the text feature based on a purified cross-modal attention distribution of the purified image. The purified cross-modal attention distribution is configured for describing attention distributions of the purified image and the text. The LVLM may focus primarily on an image region related to the text in the purified image based on the purified cross-modal attention distribution.

In some embodiments, the LVLM predicts the fused feature. The fused feature is a feature generated by the LVLM by fusing the image feature and the text feature based on the attention distributions of the image and the text in the purified cross-modal attention distribution. In some embodiments, the LVLM performs prediction based on the fused feature to obtain a question answering score for the purified sample. The question answering score is configured for indicating the correct probability that the purified sample belongs to the correct prediction result (correct category). In some embodiments, the question answering score is positively correlated with the purified cross-modal attention distribution of the purified image. In some embodiments, a score threshold is set in the LVLM. When the question answering score of the LVLM is greater than the score threshold, the purified sample belongs to the correct prediction result. When the question answering score of the LVLM is less than or equal to the score threshold, the purified sample belongs to an incorrect prediction result, indicating that the input purified sample is not a completely purified result. When the prediction result of the LVLM for the purified sample is an incorrect prediction result, the purified cross-modal attention distribution of the purified sample needs to be continuously adjusted, that is, random noise needs to be continuously added to the adversarial sample to adjust the adversarial cross-modal attention distribution of the adversarial sample.

In some embodiments, the prediction result corresponding to the question answering score is compared with a true result (the label corresponding to the purified sample) to obtain a calculation loss. The calculation loss is configured for indicating an error between the prediction result corresponding to the question answering score and the true result. In some embodiments, parameters of the LVLM are adjusted using a back propagation algorithm, so that the prediction result of the LVLM is closer to the label corresponding to the purified sample. In some embodiments, the LVLM is optimized through a loss function. The loss function may be any loss function. For example, the loss function may be a cross entropy (CE) loss function or a mean square error (MSE) loss function.

Training of the LVLM provided in this embodiment is merely exemplary description and does not constitute a limitation on the manner of training the LVLM.

In some embodiments, the LVLM may be applied to a VQA scene.

In an application scene, the sample purification method may be applied to the field of classification-based question answering. A purified sample is inputted to the LVLM, and the LVLM performs recognition based on the purified sample to obtain a correct question answering result corresponding to the purified sample.

Operation 1: Acquire a classification adversarial sample.

The classification adversarial sample is an adversarial sample generated by performing an adversarial attack on a clean sample. The classification adversarial sample includes a classification adversarial image and a question description.

In some embodiments, the adversarial attack includes slightly modifying or perturbing the clean sample. Modifications or perturbations in the classification adversarial sample are imperceptible, but they may cause the LVLM to make an incorrect prediction and generate an incorrect prediction result (output result).

Exemplarily, a clean image shows a bicycle parked at the entrance of a building. In a question answering scene, a question description for the clean image is “what material is a gate of the building”, and the LVLM correctly classifies it as “wood”. An adversarial attack is applied to the clean image. For example, an adversarial attack is performed on the clean image based on the FGSM to generate a classification adversarial image. In a question answering scene, a question description for the classification adversarial image is “what material is a gate of the building”, and the LVLM incorrectly classifies it as “metal”.

In some embodiments, the LVLM calculates an adversarial cross-modal attention distribution corresponding to the clean image based on a visual token and a language token in the clean image. In some embodiments, the clean image is encoded into image features based on a visual encoder, and the image features are aligned through the LVLM to obtain at least one visual token. Each of the at least one visual token is configured for indicating the image feature of the clean image. The question description is encoded into text features based on a language model tokenizer, and the text features are aligned through the LVLM to obtain at least one language token. Each of the at least one language token is configured for indicating the text feature of the question description. A clean cross-modal attention distribution when a clean prediction result is generated is calculated through the LVLM. The clean prediction result is a prediction result obtained after the LVLM fuses the at least one visual token and the at least one language token.

Exemplarily, when the LVLM predicts the clean image, the generated clean prediction result is “wood”. The LVLM calculates attention weights of all visual tokens in the clean image. The LVLM divides the clean image into several regions. An image feature of each region (or image features corresponding to a plurality of regions) may be represented as one visual token. The attention weight represents the importance of each visual token to the answer “wood”. That is, the LVLM evaluates the extent to which each visual token affects the generation of “wood”.

In some embodiments, when predicting the classification adversarial image, the LVLM calculates an adversarial cross-modal attention distribution of the classification adversarial image. The adversarial cross-modal attention distribution is a cross-modal attention distribution corresponding to the classification adversarial image, and is configured for describing attention distributions of the classification adversarial image and the question description. The adversarial cross-modal attention distribution of the classification adversarial image is similar to the foregoing process of the clean cross-modal attention distribution of the clean image.

Operation 2: Acquire a noisy image obtained by adding first noise to the adversarial image.

The noisy image is an image obtained after performing a first perturbation on the classification adversarial image. The first noise refers to random noise added to the classification adversarial image. The first noise is randomly generated or generated according to a rule, to perturb a pixel value of the classification adversarial image. In a possible implementation, the first noise is added through a computer program. In a possible implementation, the first noise is added through a noise model. For example, the first noise is generated using GANs, VAEs, or other deep learning models, and then added to the classification adversarial image.

Operation 3: Determine a first correlation between at least one noisy image feature of the noisy image and at least one text feature of the text.

In other words, a noisy cross-modal attention distribution corresponding to the noisy image may be calculated.

The noisy cross-modal attention distribution is configured for describing a correlation between at least one noisy image feature of the noisy image and at least one text feature of the question description text.

In a possible implementation, the first noise is added to the classification adversarial image to obtain the noisy image. Compared with the adversarial cross-modal attention distribution of the classification adversarial image, the noisy cross-modal attention distribution of the noisy image is closer to the clean cross-modal attention distribution of the clean image. Therefore, the noisy cross-modal attention distribution of the noisy image is used as a reference estimation direction to guide the optimization of the adversarial cross-modal attention distribution of the classification adversarial image. This may be regarded as a purification operation on the classification adversarial image, making the classification adversarial image closer to the clean image.

Exemplarily, a question description for the noisy image is “what material is a gate of the building”, and the LVLM may incorrectly classify it as a “brick”. However, the noisy cross-modal attention distribution corresponding to the noisy image is closer to the clean cross-modal attention distribution of the clean image.

In some embodiments, the noisy cross-modal attention distribution corresponding to the noisy image is calculated. The noisy cross-modal attention distribution refers to how the LVLM focuses on the attention (or attention weight) of the noisy image in the noisy sample when generating a prediction result based on the noisy sample. The adversarial cross-modal attention distribution of the classification adversarial image is similar to the foregoing process of the noisy cross-modal attention distribution of the noisy image.

Operation 4: Determine a second correlation between at least one adversarial image feature of the adversarial image and the at least one text feature of the text.

In other words, the adversarial cross-modal attention distribution corresponding to the adversarial image is calculated.

The adversarial cross-modal attention distribution is configured for describing a correlation between at least one adversarial image feature of the adversarial image and at least one text feature of the question description text.

Operation 5: Add second noise to the adversarial image based on the first correlation and the second correlation to purify the adversarial image to obtain a purified image.

The purified image is an image obtained after performing a second perturbation on the adversarial image. The second noise refers to random noise added to the classification adversarial image. The second noise is randomly generated or generated according to a rule, to perturb a pixel value of the classification adversarial image.

Exemplarily, a question description for the noisy image is “what material is a gate of the building”, and the LVLM may correctly classify it as “wood”. Although the purified image may be noisier visually, a purified cross-modal attention distribution of the purified image may be closer to a clean cross-modal attention distribution of the clean image. Therefore, a prediction result of the LVLM for the purified image is closer to that for the clean image.

In some embodiments, the second correlation may be guided to be close to the first correlation by continuously adding random noise to the classification adversarial image, thereby generating the purified image. In some embodiments, with a target of minimizing a correlation difference, the second noise is added to the classification adversarial image to obtain the purified image.

In some embodiments, a direction of adding the second noise may be determined. First, a norm of the correlation difference is calculated. The norm of the correlation difference is configured for measuring a distance between the first correlation and the second correlation. Then, a gradient of the correlation difference for a pixel in the classification adversarial image is calculated. Then, a gradient direction of the gradient is determined based on a sign function. This may alternatively be understood as determining a noise addition manner for each pixel based on the gradient of each pixel. The gradient direction is configured for indicating the direction of adding the second noise. In some embodiments, the gradient is used as an input of the sign function. When the gradient is a positive value, a pixel value in the adversarial image is increased according to the gradient direction. When the gradient is a negative value, the pixel value in the adversarial image is reduced according to the gradient direction. The pixel value in the adversarial image is increased or reduced according to the gradient direction to obtain the purified image added with the second noise.

In some embodiments, the magnitude of the added second noise may further be determined. In some embodiments, the gradient not only contains information of the gradient direction, but also includes intensity information. In some embodiments, a pixel having a relatively large gradient in the adversarial image shall be subjected to a large perturbation, that is, added with relatively large noise. A pixel having a relatively small gradient in the adversarial image shall be subjected to a relatively small perturbation, that is, added with relatively small noise.

In summary, the LVLM may generate incorrect predictions based on the classification adversarial sample. A purification operation is performed on the classification adversarial image in the adversarial sample to obtain the purified image, so as to obtain the purified sample. Specifically, the noisy image is obtained by performing random noise addition on the classification adversarial image. Since the noisy cross-modal attention distribution (i.e., the first correlation) of the noisy image is very close to the cross-modal attention distribution (i.e., the second correlation) corresponding to the clean image, the noisy cross-modal attention distribution of the noisy image may be used as an optimization target, and random noise is added to the classification adversarial image, so that the adversarial cross-modal attention distribution of the classification adversarial image is close to the noisy cross-modal attention distribution of the noisy image, to complete purification of the classification adversarial image and obtain the purified image. In this application, with guidance of the noisy cross-modal attention distribution, the classification adversarial image is purified by adding noise to the classification adversarial image. The LVLM may obtain a correct prediction result based on the purified image, and this purification manner enhances the robustness of the LVLM.

Quantitative Results of this Solution

This solution may be referred to as FFF. Specifically, for a clean image xᵢ in a clean sample, a prediction result f(xᵢ, xₜ) of the LVLM is also correct, and a clean cross-modal attention distribution A(xᵢ, xₜ, f) of the clean image is extracted. For an adversarial image

$${x}_{i}^{′}$$

in an adversarial sample, a prediction result

$$f ( {x}_{i}^{′} , {x}_{t} )$$

of the LVLM is incorrect, and an adversarial cross-modal attention distribution

$$A ( {x}_{i}^{′} , {x}_{t} , f )$$

of the adversarial image is extracted. It may be found through comparison that the adversarial cross-modal attention distribution of the adversarial image and the clean cross-modal attention distribution of the clean image are significantly different, which may present a significant mode difference between an adversarial cross-modal attention distribution map and a clean cross-modal attention distribution map. Through feasibility verification, that is, if the clean cross-modal attention distribution of the clean image is used as a target to optimize the adversarial image, the adversarial image may be purified.

However, in an adversarial purification scene, since the clean image is unavailable, the clean cross-modal attention distribution of the clean image cannot be extracted. Therefore, the clean cross-modal attention distribution of the clean image needs to be properly estimated. Testing shows that by adding random noise with an infinite norm limited by α_{∞} to the adversarial image of the adversarial sample, i.e.,

$$R ( {x}_{i}^{′} , {α}_{∞} ) ,$$

although a prediction result

$$f ( R ( {x}_{i}^{′} , {α}_{∞} ) , {x}_{t} )$$

of the LVLM is still incorrect, the noisy cross-modal attention distribution

$$A ( R ( {x}_{i}^{′} , {α}_{∞} ) , {x}_{t} , f )$$

has a tendency to be close to the clean cross-modal attention distribution of the clean image. If the adversarial cross-modal attention distribution of the adversarial image is optimized toward the noisy cross-modal attention distribution

$$A ( R ( {x}_{i}^{′} , {α}_{∞} ) , {x}_{t} , f ) ,$$

the adversarial image may be purified. Experiments confirm this to be true. The adversarial cross-modal attention distribution of the randomly noised adversarial image is used as a target, and noise is added to the adversarial image to obtain a purified image. Its answer

$$f ( {x}_{i}^{p} , {x}_{t} )$$

is correct, and a purified cross-modal attention distribution

$$A ( {x}_{i}^{p} , {x}_{t} , f )$$

of the purified image is also indeed more similar to the clean cross-modal attention distribution of the clean image.

Some quantitative results are given below.

First, in this solution, it is verified whether the adversarial image may be purified using the clean cross-modal attention distribution of the clean image. In this solution, the clean cross-modal attention distribution of the clean image is used as a target, and noise is added to the adversarial image. The result is shown in Table 1. Higher noise intensity indicates a better purification effect, and the cross-modal attention distribution corresponding to the adversarial image added with noise is actually closer to the clean cross-modal attention distribution of the clean image.

TABLE 1

| | Clean | Adversarial | Value of added noise | | | | | | |
|---|---|---|---|---|---|---|---|---|---|
| | image | image | 1/255 | 2/255 | 4/255 | 8/255 | 16/255 | 24/255 | 32/255 |
| VQA score | 75.95 | 24.88 | 26.24 | 27.11 | 27.85 | 30.65 | 36.77 | 41.64 | 45.89 |
| MSE | 0 | 10.31 | 12.83 | 12.34 | 11.74 | 10.85 | 9.65 | 8.30 | 7.89 |
| KL divergence | 0 | 3.39 | 3.94 | 3.79 | 3.63 | 3.41 | 3.04 | 2.65 | 2.54 |

The MSE is the L₂ norm mentioned above. The VQA score is a visual question answering score of the LVLM based on the input image. In Table 1, the first row shows the score (VQA score) of the LVLM, and the second row and the third row measure a difference between the cross-modal attention distribution corresponding to the adversarial image added with noise and the clean cross-modal attention distribution corresponding to the clean image.

Then, in this solution, the impact of a noisy image, obtained by randomly adding noise to the adversarial image, on the prediction result and the cross-modal attention distribution is verified. It can be seen from Table 2 that, as the noise intensity increases, the VQA score of the LVLM increases to some extent but not significantly, while the noisy cross-modal attention distribution corresponding to the noisy image is closer to the clean cross-modal attention distribution of the clean image.

TABLE 2

| | Clean | Noisy | Value of added noise | | | | | | |
|---|---|---|---|---|---|---|---|---|---|
| | image | image | 1/255 | 2/255 | 4/255 | 8/255 | 16/255 | 24/255 | 32/255 |
| VAQ score | 75.95 | 24.88 | 24.88 | 24.79 | 24.88 | 25.01 | 24.80 | 26.92 | 31.34 |
| MSE | 0 | 16.03 | 16.01 | 16.06 | 15.99 | 15.85 | 14.92 | 13.42 | 12.02 |
| KL divergence | 0 | 4.91 | 4.90 | 4.91 | 4.89 | 4.83 | 4.46 | 3.91 | 3.34 |

In this solution, a noisy cross-modal attention distribution of a noisy image added with random noise is used as an estimation of a clean cross-modal attention distribution of a clean image, and noise is added to the adversarial image. The magnitude of the noise is randomly selected, and an estimated noisy cross-modal attention distribution controller direction is used. The result is shown in Table 3. The first row shows a random direction, and the method of this solution starts to be shown from the second row. It can be seen that this solution can actually realize performance purification to some extent. Each row shows the noise intensity added to estimate the clean cross-modal attention distribution of the clean image, and each column shows the noise intensity added to purify the adversarial image.

TABLE 3

| | Add noise according to the method of this solution | | | | | | |
|---|---|---|---|---|---|---|---|
| | 1/255 | 2/255 | 4/255 | 8/255 | 16/255 | 24/255 | 32/255 |
| Random | 24.88 | 24.79 | 24.88 | 25.01 | 24.80 | 26.92 | 31.34 |
| direction | | | | | | | |
| 1/255 | 25.56 | 26.41 | 27.15 | 29.42 | 34.52 | 40.04 | 43.63 |
| 2/255 | 25.35 | 26.20 | 27.48 | 30.19 | 35.57 | 41.28 | 44.59 |
| 4/255 | 26.03 | 26.40 | 27.19 | 30.36 | 36.41 | 42.73 | 45.50 |
| 8/255 | 26.38 | 27.01 | 28.14 | 31.42 | 35.88 | 42.83 | 45.15 |
| 16/255 | 27.09 | 27.86 | 25.86 | 31.91 | 37.16 | 42.60 | 46.15 |
| 24/255 | 26.73 | 27.65 | 28.46 | 30.47 | 36.81 | 42.32 | 46.85 |
| 32/255 | 26.79 | 27.68 | 28.31 | 31.00 | 35.97 | 41.33 | 45.32 |

In the foregoing solution, only the noise direction is controlled, and the noise magnitude is randomly selected. In this solution, the noise magnitude is further controlled. The result is shown in Table 4. The first row shows a random direction, and the method of this solution starts to be shown from the second row. It can be seen that controlling the noise magnitude yields a better effect than optimization by controlling the direction alone.

TABLE 4

| | Add noise according to the method of this solution | | | | | | |
|---|---|---|---|---|---|---|---|
| | 1/255 | 2/255 | 4/255 | 8/255 | 16/255 | 24/255 | 32/255 |
| Random | 24.88 | 24.79 | 24.88 | 25.01 | 24.80 | 26.92 | 31.34 |
| direction | | | | | | | |
| 1/255 | 25.29 | 27.01 | 28.66 | 33.90 | 42.70 | 48.90 | 53.48 |
| 2/255 | 25.74 | 26.77 | 28.82 | 34.66 | 43.69 | 49.48 | 52.33 |
| 4/255 | 25.41 | 27.15 | 29.53 | 35.55 | 44.46 | 50.44 | 53.56 |
| 8/255 | 25.45 | 26.77 | 30.17 | 36.06 | 45.74 | 51.37 | 55.42 |
| 16/255 | 26.50 | 28.02 | 30.36 | 35.99 | 45.39 | 52.29 | 54.74 |
| 24/255 | 25.99 | 28.07 | 31.38 | 36.63 | 46.08 | 52.79 | 53.51 |
| 32/255 | 26.62 | 28.11 | 30.66 | 36.41 | 45.48 | 52.36 | 54.33 |

FIG. 7 is a structural block diagram of a sample purification apparatus according to an embodiment of this application. The sample purification apparatus has a function of implementing the foregoing sample purification method examples, and the function may be implemented by hardware or may be implemented by hardware executing corresponding software. The purification apparatus may be the server described above, or may be provided in the server. As shown in FIG. 7, the purification apparatus may include an acquisition module 710, a determining module 720, and an addition module 730.

The acquisition module 710 is configured to:
acquire an adversarial sample, the adversarial sample being generated by performing an adversarial attack on a clean sample, and the adversarial sample including an adversarial image and text; and
acquire a noisy image obtained by adding first noise to the adversarial image.

The determining module 720 is configured to:
determine a first correlation between at least one noisy image feature of the noisy image and at least one text feature of the text; and
determine a second correlation between at least one adversarial image feature of the adversarial image and the at least one text feature of the text.

The addition module 730 is configured to add second noise to the adversarial image based on the first correlation and the second correlation to purify the adversarial image to obtain a purified image.

In some embodiments, the addition module 730 is specifically configured to add, with a target of minimizing a correlation difference, the second noise to the adversarial image to purify the adversarial image to obtain the purified image, the correlation difference being a difference between the first correlation and the second correlation.

In some embodiments, the addition module 730 is specifically configured to calculate a norm of the correlation difference, the norm being configured for measuring a distance between the first correlation and the second correlation; calculate a gradient of the norm of the correlation difference for each pixel in the adversarial image; and determine a noise addition manner for each pixel based on the gradient of each pixel, and add the second noise to each pixel according to the noise addition manner for each pixel to obtain the purified image.

In some embodiments, the addition module 730 is specifically configured to determine, when a gradient of an i^{th} pixel in the adversarial image is a positive value, that a noise addition manner for the i^{th} pixel is a first noise addition manner, the first noise addition manner being configured for adding the second noise to a pixel value of the i^{th} pixel to increase the pixel value of the i^{th} pixel, i being a positive integer; determine, when the gradient of the i^{th} pixel is a negative value, that the noise addition manner for the i^{th} pixel is a second noise addition manner, the second noise addition manner being configured for adding the second noise to the pixel value of the i^{th} pixel to decrease the pixel value of the i^{th} pixel; and add the second noise to each pixel based on the noise addition manner for each pixel in the adversarial image to obtain the purified image.

In some embodiments, the gradient includes intensity information, and the determining module 720 is further configured to determine the second noise corresponding to each pixel in the adversarial image based on the intensity information of the gradient, the intensity information being configured for indicating a magnitude of the gradient of each pixel in the adversarial image.

In some embodiments, the determining module 720 is specifically configured to acquire a first gradient value and a second gradient value, the first gradient value being a maximum gradient value of all pixels in the adversarial image, and the second gradient value being a minimum gradient value of all pixels in the adversarial image; obtain a standard gradient value based on the first gradient value and the second gradient value, the standard gradient value being a gradient value obtained after normalizing the gradient; determine a perturbation amplitude of the second noise according to the standard gradient value and an average value of standard gradient values, the perturbation amplitude including a perturbation factor configured for determining a magnitude of the second noise; and determine, based on the perturbation factor, the magnitude of the second noise added to each pixel in the adversarial image, the magnitude of the second noise being positively correlated with the intensity information of the gradient.

In some embodiments, the perturbation factor is a maximum value of a first normalized value and a first value, the first value is a minimum value of a second normalized value and a second value, and the second value is a quotient of the standard gradient value and the average value of the standard gradient values; and the first normalized value is 0, and the second normalized value is 1.

In some embodiments, the purification apparatus further includes a generation module 740. The acquisition module 710 is further configured to acquire a purified sample, the purified sample including the purified image and the text. The generation module 740 is configured to generate a prediction result for the purified image through an LVLM based on the purified sample, the prediction result for the purified image being a correct prediction result.

In some embodiments, the determining module 720 is specifically configured to determine the first correlation through the LVLM.

In some embodiments, the LVLM includes a visual encoder and a language model tokenizer. The determining module 720 is specifically configured to: divide the noisy image into a plurality of regions based on the visual encoder, and encode each region into a regional image feature; align regional image features of the plurality of regions through the LVLM to obtain the at least one noisy image feature; divide the text into a plurality of text units based on the language model tokenizer, and encode each text unit into a text unit feature; align text unit features of the plurality of text units through the LVLM to obtain the at least one text feature; and calculate, through the LVLM, the first correlation when a noisy prediction result is generated, the noisy prediction result being a prediction result obtained after the LVLM fuses at least one visual token and at least one language token of the noisy image; each visual token corresponding to one noisy image feature; and each language token corresponding to one text feature.

In some embodiments, the determining module 720 is specifically configured to determine the second correlation through the LVLM.

In some embodiments, the LVLM includes a visual encoder and a language model tokenizer. The determining module 720 is specifically configured to divide the adversarial image into a plurality of regions based on the visual encoder, and encode each region into a regional image feature; align regional image features of the plurality of regions through the LVLM to obtain the at least one adversarial image feature; divide the text into a plurality of text units based on the language model tokenizer, and encode each text unit into a text unit feature; align text unit features of the plurality of text units through the LVLM to obtain the at least one text feature; and calculate, through the LVLM, the second correlation when an adversarial prediction result is generated, the adversarial prediction result being a prediction result obtained after the LVLM fuses at least one visual token and at least one language token of the adversarial image; each visual token corresponding to one adversarial image feature; and each language token corresponding to one text feature.

In some embodiments, the first noise is determined based on a first noise value obtained through pseudo-random sampling within a first distribution interval.

In some embodiments, the first distribution interval is a uniformly distributed interval range.

In some embodiments, the second noise is determined based on a second noise value obtained through pseudo-random sampling within a second distribution interval.

In some embodiments, the second distribution interval is a uniformly distributed interval range.

In some embodiments, the clean sample includes a clean image and text. The determining module 720 is further configured to determine a third correlation between at least one clean image feature of the clean image and at least one text feature of the text, the first correlation being closer to the third correlation than the second correlation.

A specific limitation of one or more sample purification apparatuses provided above may refer to the foregoing limitation for the sample purification method. Details are not described herein again. The modules of the foregoing purification apparatus may be completely or partially implemented through software, hardware, and a combination thereof. The modules may be embedded in the form of hardware or stored separately from a processor of a computer device, or may be stored in the form of software in a memory of the computer device, facilitating the processor to call the modules to perform the corresponding operations.

The sequence numbers of the foregoing embodiments of this application are merely for the purpose of description and do not represent the advantages and disadvantages of the embodiments.

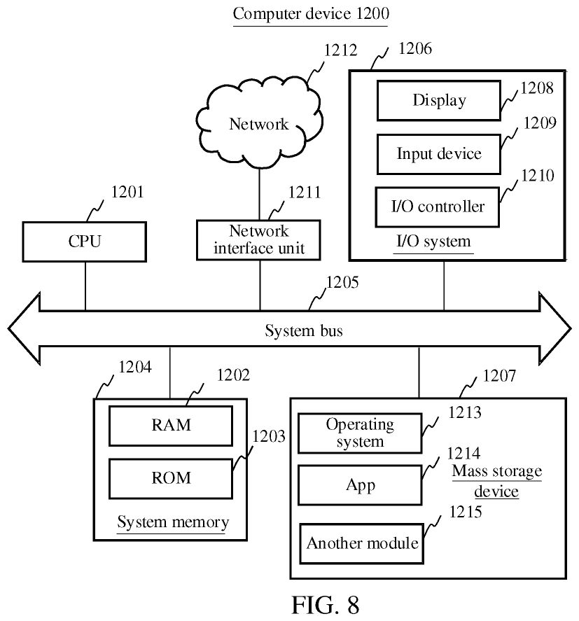

FIG. 8 is a structural block diagram of a computer device 1200 according to an exemplary embodiment of this application. The computer device may be configured to implement the sample purification method provided in the foregoing embodiments. The computer device 1200 includes a central processing unit (CPU) 1201, a system memory 1204 including a random access memory (RAM) 1202 and a read-only memory (ROM) 1203, and a system bus 1205 connecting the system memory 1204 and the CPU 1201. The computer device 1200 further includes a basic input/output (I/O) system 1206 assisting in information transmission between components in the computer device, and a mass storage device 1207 configured to store an operating system 1213, an App 1214, and another program module 1215.

The basic I/O system 1206 includes a display 1208 configured to display information and an input device 1209 such as a mouse or a keyboard that is configured to input information by a user. The display 1208 and the input device 1209 are both connected to the CPU 1201 using an I/O controller 1210 connected to the system bus 1205. The basic I/O system 1206 may further include the I/O controller 1210 to be configured to receive and process inputs from a plurality of other devices such as a keyboard, a mouse, and an electronic stylus. Similarly, the I/O controller 1210 further provides an output to a display screen, a printer, or another type of output device.

The mass storage device 1207 is connected to the CPU 1201 through a mass storage controller (not shown) connected to the system bus 1205. The mass storage device 1207 and a computer-readable storage medium associated with the mass storage device provide non-volatile storage for the terminal device 1200. In other words, the mass storage device 1207 may include a computer-readable storage medium (not shown) such as a hard disk or a compact disc ROM (CD-ROM) drive.

Without loss of generality, the computer-readable storage medium may include a computer storage medium and a communication medium. The computer storage medium includes volatile and non-volatile media, and removable and non-removable media implemented using any method or technology configured for storing information such as computer-readable storage instructions, data structures, program modules, or other data. The computer storage medium includes a RAM, a ROM, an erasable programmable ROM (EPROM), an electrically-erasable programmable ROM (EEPROM), a flash memory or another solid-state memory technology, a CD-ROM, a digital versatile disc (DVD) or another optical memory, a magnetic cassette, a magnetic tape, a magnetic disk memory, or another magnetic storage device. It is clear that a person skilled in the art may learn that the computer storage medium is not limited to the foregoing several types. The system memory 1204 and the mass storage device 1207 may be collectively referred to as a memory.

The memory stores one or more programs. The one or more programs are configured to be executed by one or more CPUs 1201. The one or more programs contain instructions configured for implementing the foregoing method embodiments. The CPU 1201 executes the one or more programs to implement the sample purification method provided in the foregoing method embodiments.

According to various embodiments of this application, the computer device 1200 may further be connected, through a network such as the Internet, to a remote terminal device on the network for running. That is, the computer device 1200 may be connected to a network 1212 through a network interface unit 1211 connected to the system bus 1205, or may be connected to another type of network or a remote terminal device system (not shown) using the network interface unit 1211.

The memory further includes one or more programs. The one or more programs are stored in the memory and contain operations of sample purification performed by the electronic device in the method provided in the embodiments of this application.

The embodiments of this application further provide a computer-readable storage medium, having at least one computer program stored therein. The at least one computer program is loaded and executed by a processor to implement the sample purification method provided in the foregoing method embodiments.

The embodiments of this application further provide a computer program product, including a computer program. The computer program is stored in a computer-readable storage medium. The computer program is read from the computer-readable storage medium and executed by a processor of a computer device to cause the computer device to perform the sample purification method provided in the foregoing method embodiments.

In the specific implementations of this application, the data involved, including historical data, portraits, and other user-related data associated with user identity or characteristics, requires user permission or consent when the foregoing embodiments of this application are applied to specific products or technologies. Collection, use, and processing of relevant data need to comply with relevant laws, regulations, and standards of relevant countries and regions.

Unless otherwise explicitly defined herein, all terms used in the claims are explained according to their ordinary meanings in the technical field. Unless otherwise explicitly stated, all reference to “an element, an apparatus, a component, a device, an operation, or the like” is to be openly interpreted as referring to at least one instance of the element, the apparatus, the component, the device, the operation, or the like. Unless explicitly stated, operations of any method disclosed herein do not need to be performed in the exact sequence disclosed.

“A plurality of” mentioned herein refers to two or more. “And/or” describes an association relationship of associated objects and represents that three relationships may exist. For example, A and/or B may represent the following three cases: only A exists, both A and B exist, and only B exists. The character “/” generally represents an “or” relationship between the associated objects.

What is claimed is:

1. A sample purification method, comprising:
acquiring an adversarial sample, the adversarial sample being generated by performing an adversarial attack on a clean sample, and the adversarial sample comprising an adversarial image and text;
acquiring a noisy image obtained by adding first noise to the adversarial image;
determining a first correlation between at least one noisy image feature of the noisy image and at least one text feature of the text;
determining a second correlation between at least one adversarial image feature of the adversarial image and the at least one text feature of the text; and
adding second noise to the adversarial image based on the first correlation and the second correlation to purify the adversarial image to obtain a purified image.

2. The method according to claim 1, wherein the adding second noise to the adversarial image based on the first correlation and the second correlation to purify the adversarial image to obtain a purified image comprises:
adding, with a target of minimizing a correlation difference, the second noise to the adversarial image to purify the adversarial image to obtain the purified image,
the correlation difference being a difference between the first correlation and the second correlation.

3. The method according to claim 2, wherein the adding, with a target of minimizing a correlation difference, the second noise to the adversarial image to purify the adversarial image to obtain the purified image comprises:
calculating a norm of the correlation difference, the norm being configured for measuring a distance between the first correlation and the second correlation;
calculating a gradient of the norm of the correlation difference for each pixel in the adversarial image; and
determining a noise addition manner for each pixel based on the gradient of each pixel, and adding the second noise to each pixel according to the noise addition manner for each pixel to obtain the purified image.

4. The method according to claim 3, wherein the determining a noise addition manner for each pixel based on the gradient of each pixel, and adding the second noise to each pixel according to the noise addition manner for each pixel to obtain the purified image comprises:
determining, when a gradient of an i^{th} pixel in the adversarial image is a positive value, that a noise addition manner for the i^{th} pixel is a first noise addition manner, the first noise addition manner being configured for adding the second noise to a pixel value of the i^{th} pixel to increase the pixel value of the i^{th} pixel, i being a positive integer;
determining, when the gradient of the i^{th} pixel is a negative value, that the noise addition manner for the i^{th} pixel is a second noise addition manner, the second noise addition manner being configured for adding the second noise to the pixel value of the i^{th} pixel to decrease the pixel value of the i^{th} pixel; and
adding the second noise to each pixel based on the noise addition manner for each pixel in the adversarial image to obtain the purified image.

5. The method according to claim 3, wherein the gradient comprises intensity information, and the method further comprises:
determining the second noise corresponding to each pixel in the adversarial image based on the intensity information of the gradient, the intensity information being configured for indicating a magnitude of the gradient of each pixel in the adversarial image.

6. The method according to claim 5, wherein the determining the second noise corresponding to each pixel in the adversarial image based on the intensity information of the gradient comprises:
acquiring a first gradient value and a second gradient value, the first gradient value being a maximum gradient value of all pixels in the adversarial image, and the second gradient value being a minimum gradient value of all pixels in the adversarial image;
obtaining a standard gradient value based on the first gradient value and the second gradient value, the standard gradient value being a gradient value obtained after normalizing the gradient;
determining a perturbation amplitude of the second noise according to the standard gradient value and an average value of standard gradient values, the perturbation amplitude comprising a perturbation factor configured for determining a magnitude of the second noise; and
determining, based on the perturbation factor, the magnitude of the second noise added to each pixel in the adversarial image, the magnitude of the second noise being positively correlated with the intensity information of the gradient.

7. The method according to claim 6, wherein the perturbation factor is a maximum value of a first normalized value and a first value, the first value is a minimum value of a second normalized value and a second value, and the second value is a quotient of the standard gradient value and the average value of the standard gradient values; and the first normalized value is 0, and the second normalized value is 1.

8. The method according to claim 1, further comprising:
acquiring a purified sample, the purified sample comprising the purified image and the text; and
generating a prediction result for the purified image through a large vision-language model (LVLM) based on the purified sample, the prediction result for the purified image being a correct prediction result.

9. The method according to claim 1, wherein the determining a first correlation between at least one noisy image feature of the noisy image and at least one text feature of the text comprises:
determining the first correlation through the LVLM.

10. The method according to claim 9, wherein the LVLM comprises a visual encoder and a language model tokenizer; and
the determining the first correlation through the LVLM comprises:
dividing the noisy image into a plurality of regions based on the visual encoder, and encoding each region into a regional image feature;
aligning regional image features of the plurality of regions through the LVLM to obtain the at least one noisy image feature;
dividing the text into a plurality of text units based on the language model tokenizer, and encoding each text unit into a text unit feature;
aligning text unit features of the plurality of text units through the LVLM to obtain the at least one text feature; and
calculating, through the LVLM, the first correlation when a noisy prediction result is generated, the noisy prediction result being a prediction result obtained after the LVLM fuses at least one visual token and at least one language token of the noisy image; each visual token corresponding to one noisy image feature; and each language token corresponding to one text feature.

11. The method according to claim 1, wherein the determining a second correlation between at least one adversarial image feature of the adversarial image and the at least one text feature of the text comprises:
determining the second correlation through the LVLM.

12. The method according to claim 11, wherein the LVLM comprises a visual encoder and a language model tokenizer; and
the determining the second correlation through the LVLM comprises:
dividing the adversarial image into a plurality of regions based on the visual encoder, and encoding each region into a regional image feature;
aligning regional image features of the plurality of regions through the LVLM to obtain the at least one adversarial image feature;
dividing the text into a plurality of text units based on the language model tokenizer, and encoding each text unit into a text unit feature;
aligning text unit features of the plurality of text units through the LVLM to obtain the at least one text feature; and
calculating, through the LVLM, the second correlation when an adversarial prediction result is generated, the adversarial prediction result being a prediction result obtained after the LVLM fuses at least one visual token and at least one language token of the adversarial image, each visual token corresponding to one adversarial image feature, and each language token corresponding to one text feature.

13. The method according to claim 1, wherein the first noise is determined based on a first noise value obtained through pseudo-random sampling within a first distribution interval.

14. The method according to claim 13, wherein the first distribution interval is a uniformly distributed interval range.

15. The method according to claim 1, wherein the second noise is determined based on a second noise value obtained through pseudo-random sampling within a second distribution interval.

16. The method according to claim 15, wherein the second distribution interval is a uniformly distributed interval range.

17. The method according to claim 1, wherein the clean sample comprises a clean image and text; and the method further comprises:
determining a third correlation between at least one clean image feature of the clean image and at least one text feature of the text,
the first correlation being closer to the third correlation than the second correlation.

18. An apparatus comprising:
a memory storing at least one computer program; and
a processor configured to execute the at least one computer program, wherein upon execution of the at least one computer program, the processor is configured to:
acquire an adversarial sample, the adversarial sample being generated by performing an adversarial attack on a clean sample, and the adversarial sample comprising an adversarial image and text;
acquire a noisy image obtained by adding first noise to the adversarial image;
determine a first correlation between at least one noisy image feature of the noisy image and at least one text feature of the text;
determine a second correlation between at least one adversarial image feature of the adversarial image and the at least one text feature of the text; and
add second noise to the adversarial image based on the first correlation and the second correlation to purify the adversarial image to obtain a purified image.

19. The apparatus of claim 18, wherein to add the second noise to the adversarial image based on the first correlation and the second correlation to purify the adversarial image to obtain the purified image, the processor is configured to:
add, with a target of minimizing a correlation difference, the second noise to the adversarial image to purify the adversarial image to obtain the purified image,
the correlation difference being a difference between the first correlation and the second correlation.

20. A non-transitory computer-readable storage medium having at least one computer program stored therein, and the at least one computer program configured to be loaded and executed by a processor, wherein when loaded and executed by the processor, the at least one computer program is configured to cause the processor to:
acquire an adversarial sample, the adversarial sample being generated by performing an adversarial attack on a clean sample, and the adversarial sample comprising an adversarial image and text;
acquire a noisy image obtained by adding first noise to the adversarial image;
determine a first correlation between at least one noisy image feature of the noisy image and at least one text feature of the text;
determine a second correlation between at least one adversarial image feature of the adversarial image and the at least one text feature of the text; and
add second noise to the adversarial image based on the first correlation and the second correlation to purify the adversarial image to obtain a purified image.
